(19) United States
(12) Patent Application Publication
(10) Pub. No.: US 2015/0134501 A1
(43) Pub. Date: May 14, 2015

(54) Computer-Implemented Systems and Methods for Hedging with Contractual Flows

(71) Applicant: SAS Institute Inc., Cary, NC (US)

(72) Inventors: Wei Chen, Apex, NC (US); Klas Jimmy Skoglund, Motala (SE)

(21) Appl. No.: 14/537,557

(22) Filed: Nov. 10, 2014

Related U.S. Application Data
(60) Provisional application No. 61/901,561, filed on Nov. 8, 2013.

(51) Int. Cl. G06Q 40/02

(52) U.S. Cl. CPC G06Q 40/02
USPC 705/35

(57) ABSTRACT

This disclosure describes computer-program products, systems and computer-implemented methods for optimal liquidity reserve planning. Liquidity portfolio optimization models are disclosed that hedge with contractual cash flows and/or hedge with counterbalancing capacity. With respect to hedging with contractual cash flows, disclosed embodiments receive a minimum solvency rate for a simulation of future events that specifies a percentage of simulation scenarios in which a solvent stress test outcome is achieved, and a minimum cost portfolio is identified that provides solvency in a percentage of simulation scenarios that meets or exceeds the minimum solvency rate. With respect to hedging with counterbalancing capacity, a hedging portfolio is structured by executing a liquidity portfolio optimization model, which prescribes a series of liquidity execution actions related to management of the hedging portfolio with respect to at least one random simulation scenario.

### CROSS-REFERENCE TO RELATED APPLICATIONS

This is a non-provisional of and claims the benefit and priority under 35 U.S.C. §119(e) of U.S. Provisional App. No. 61/901,561, titled “Optimal Liquidity Reserve Planning System and Method”. That U.S. Provisional Application was filed on Nov. 8, 2013, and is incorporated by reference herein for all purposes.

This application is being filed concurrently with a non-provisional application entitled, “Computer-Implemented Systems and Methods for Hedging with Counterbalancing Capacity”, which also claims the benefit and priority under 35 U.S.C. §119(e) of U.S. Provisional App. No. 61/901,561, titled “Optimal Liquidity Reserve Planning System and Method”.

### TECHNICAL FIELD

Aspects of this disclosure generally relate to bank financial and liquidity risk management and asset allocation.

### BACKGROUND

Liquidity risk management is the management of the bank's ability to meet its obligations as they come due, without incurring losses. One of banks' core business functions is to provide liquidity intermediation between consumers and investors. To fulfill this role, banks constantly enter into contracts that provide liquidity and liquidity insurance. Due to the increasingly complex banking products and reliance on the capital market financing, liquidity risk management is seen to be of paramount importance and a subject of great interest for regulators because a liquidity shortfall at a single significant institution can lead to system-wide effects.

Unfavorable funding gaps that need to be mitigated can arise due to bank-specific stress such as an increase in withdrawal of consumers' deposits with the bank and a cancellation of a credit facility offered to the bank. Funding gaps can become even worse when the bank at the same time experiences significant contractual flow changes, e.g., cash flow changes caused by a large number of payment delinquencies and increased use of the committed line of credit to its customers. Unfavorable funding gaps can also arise because of a general economic downturn. For example, an adverse market scenario can cause increased derivatives margin requirements and increased collateral posting due to reduced value of collateral.

### BRIEF SUMMARY

There are significant cash flow (inflow and outflow) landscape changes under stress scenarios that give rise to funding gaps. Thus, it is important for a financial institution to simulate these stress scenarios and model its cash flows under these scenarios. The optimization methods proposed by embodiments of this disclosure require simulation and cash flow modeling, which increase the effectiveness of the optimization results.

This disclosure describes a computer-program product comprising a non-transitory machine-readable storage medium that includes instructions operable to cause a data processing apparatus to perform operations including accessing information representing assets and liabilities of an entity; accessing a representation of a time horizon specified with respect to a series of consecutive future time periods; generating representations of multiple simulation scenarios on a computing device, wherein the multiple simulation scenarios include one or more impacts associated with hypothetical events during the time horizon, and wherein the one or more impacts are forecasted using the hypothetical events and the information representing assets and liabilities; receiving input corresponding to a minimum rate for a simulation of future events associated with the multiple simulation scenarios, wherein the minimum rate specifies a percentage of simulation scenarios in which a stress test outcome is achieved; and identifying a minimum plan for the entity, wherein executing the minimum plan meets or exceeds the minimum rate, wherein identifying the minimum plan includes processing the representations of the simulation scenarios by executing an optimization model subject to at least one constraint, and wherein the optimization model is executed on the computing device and corresponds to the minimum plan. A system comprising a processor configured to perform these operations is also described, as is a computer-implemented method comprising these operations.

This disclosure further describes a computer-program product comprising a non-transitory machine-readable storage medium that includes instructions operable to cause a data processing apparatus to perform operations including obtaining information representing assets and liabilities of an entity; obtaining a representation of a time horizon defined with respect to a series of consecutive future time periods; generating representations of multiple simulation scenarios on a computing device, wherein the multiple simulation scenarios include one or more impacts associated with hypothetical events during the time horizon, and wherein the one or more impacts are forecasted based on the hypothetical events and the information representing the assets and liabilities; and structuring a hedging plan by executing an optimization model subject to at least one constraint, wherein the optimization model is executed on the computing device and prescribes, with respect to at least one of the simulation scenarios, a series of actions related to management of the hedging plan. A system comprising a processor configured to perform these operations is also described, as is a computer-implemented method comprising these operations.

### BRIEF DESCRIPTION OF THE DRAWINGS

Aspects of the disclosure are illustrated by way of example. In the accompanying figures, like reference numbers indicate similar elements, and:

FIG. 1 is an illustration of a bank's cash flow environment over multiple periods, and is displayed with regards to multiple cash flow categories.

FIG. 2 is a diagram illustrating results of liquidity management using a liquidity hedging portfolio.

FIG. 3 is a block diagram of an example liquidity planning system, as described in this disclosure.

FIG. 4A shows an example of a server operated within a liquidity planning system.

FIG. 4B is a screenshot from a graphical display that shows one example of functionality provided at a graphical display interface.

FIG. 4C is a screenshot from a graphical display that shows an additional example of functionality at a graphical display interface.

FIG. 4D is a screenshot from a graphical display that shows one example of functionality for comparing a bank's portfolio composition at present to an optimized portfolio.

FIG. 4E is a screenshot from a graphical display, and is an example of functionality that enables a user to study a bank's net liquidity gaps, cash inflows and outflows, and cumulative and hedged liquidity gaps.

FIG. 5 is a data and process diagram related to a contractual assets portfolio optimization performed by the liquidity planning system.

FIG. 6 depicts example operations for optimizing a contractual assets portfolio.

FIG. 7 depicts example operations for optimizing a counterbalancing portfolio.

FIG. 8 shows a data and process diagram related to a counterbalancing portfolio optimization.

FIG. 9 is an example of counterbalancing portfolio trading recommendations prescribed by the liquidity planning system.

FIG. 10 depicts an example of operations performed by a liquidity planning system.

FIG. 11 depicts an example of operations performed by a liquidity planning system.

### DETAILED DESCRIPTION OF THE DRAWINGS

The present disclosure provides a computerized optimal liquidity planning and execution system (hereinafter also referred to as the “planning system”). In providing liquidity mediation, a bank's management may wish to manage liquidity risk by endowing a portfolio of loans, bonds, and other assets that, while passively managed, provides relatively predictable cash inflows that expected to complement cash outflows, during all but a handful of extreme scenarios. This type of portfolio will be referred to hereinafter as a “liquidity portfolio” or “plan”, and may include some or all of the asset types on a bank's balance sheet.

It may also be beneficial for a bank to create the liquidity portfolio by endow two different types of portfolios that contribute to the overall liquidity portfolio. For example, banks often hold portfolios of illiquid assets of a contractual nature, and try to balance cash outflows with the cash inflows that these assets generate. Banks often simultaneously hold smaller portfolios of liquid assets that may be less profitable, but which provide a form of liquidity buffer, also known in the industry as counterbalancing capacity for the rare scenarios in which the illiquid, contractual assets are insufficient to balance cash outflows.

The liquidity planning system provides functionality for cash flow matching strategies centered around the contractual assets and liabilities. In providing the cash flow matching functionality, the planning system analyzes a bank's current balance sheet and projects cash outflows (e.g., cash flow impacts) that would be incurred by the bank in the event of several different hypothetical scenarios. Based on these projections, the liquidity planning system structures the lowest cost, passively managed liquidity portfolio that is forecast to provide matching cash flows in a manner that satisfies a mismatch tail risk criteria specified as a minimum percentage of the scenarios that the bank could withstand using the contractual assets alone. In other words, the liquidity planning system chooses and allocates assets in the liquidity portfolio so that the probability that the portfolio will provide offsetting cash flows throughout the planning horizon exceeds the tail risk criteria.

The planning system also includes functionality for determining optimal hedging strategies based on the use of counterbalancing capacity (CBC). The CBC functionality can be operated in conjunction with, or independently of, any use of the cash flow matching functionality by the bank. Thus, when using the liquidity planning system, a bank's managers may determine to make liquidity planning decisions using either the cash flow matching functionality, the CBC functionality, or both.

When the contractual cash flow matching and the CBC functionality are used, whether alone or together, the liquidity planning system can generate multiple randomized scenarios and analyze the bank balance sheet to forecast a series of impacts (such as, for example, cash flow impacts) that would be occasioned by each scenario in the future. The series of impacts can be specified with respect to time periods during the liquidity planning horizon.

The liquidity planning system also determines available assets and liquidity generating facilities and opportunities available to the bank, and the costs of accessing these liquidity sources. With regards to planning for the purposes of cash flow matching, the available assets and liquidity generating facilities include complementary contracts, asset backed commercial paper, deposits, existing lines of credit, and interbank borrowing. Complementary contracts are derivative contracts that provide complementary cash flows through contractual agreements. For example, swaps are used by the bank to hedge for the funding rate or foreign exchange rate changes that will induce cash flow differences. Credit derivatives can protect the banks from cash flow shortage due to defaulted payments. The liquidity system then processes the information about the current state of the bank's balance sheet, the impacts forecasted for the various scenarios, and the liquidity opportunities, in order to identify the lowest cost liquidity portfolio expected to satisfy the tail risk criteria.

In a typical liquidity risk management scenario, a bank's officers must decide how to manage the bank's balance sheet. Critical decisions in this process relate to how the bank's assets should be allocated, and how interbank lending markets should be used. The present disclosure describes a computerized planning system for informing several of these decisions.

As described in this disclosure, a computerized planning system uses various models and simulation techniques to inform risk management decision making.

The computerized planning system accesses a rich supply of historical data related to various factors that may affect a bank's cash flow situation. For example, the factors may include cash flow effects related to any of the bank's assets, liabilities, as well as assets or liabilities which are not currently on the bank's balance sheet, but may be at a future time. The factors may also include the interest rate at which the bank can borrow money, and any other factor which could affect the bank's solvency.

The computerized planning system uses the historical data or expert suggested future scenarios for example the macroeconomic scenarios provide by the Federal Reserve Bank every year for the CCAR process, to model how changing economic and financial circumstances have interacted with the factors that affect the bank's cash flow situation. The computerized planning system uses the historical data in conjunction with a simulation engine that generates randomized simulation paths which represent equally probable future economic developments. The simulation paths are represented as hypothetical future changes in economic, banking, credit and political circumstances during particular periods of time. Based on the interactions between these circumstances and the various components of the bank's cash flow, the computerized planning system assigns period-by-period cash flow impacts to each simulation path. In this process, the system determines a different cash flow impact for each time period of each simulation path.

This computerized liquidity planning system provides optimization capabilities and features that process information about a bank's balance sheet condition to identify the portfolio allocation expected to realize the highest profit in a manner that satisfies the cash flow matching condition.

As part of an overall liquidity hedging portfolio, a contractual assets portfolio is intended to be both the bank's core source of liquidity—and profit generation. As a core source of positive cash flow, the contractual assets portfolio alone should be structured to provide liquidity coverage in a large majority of hypothetical economic situations that could come to fruition. Accordingly, a contractual assets portfolio may include assets such as loans and real estate leases that offer a reasonable rate of return and involve a contractual obligation for payments to be made on a fixed schedule.

However, if a primary portfolio were designed to provide liquidity coverage in all hypothetical scenarios, it would be overly secure and the bank holding it would lose opportunity to generate profit.

The management of an additional asset portfolio that can be used to generate liquidity capacity (also known as counterbalancing capacity) in liquidity distress is quickly emerging as an important function in banks. The new Basel III liquidity risk regulation underscores the importance of banks managing a liquidity contingency buffer. The focus is on maintaining a high-quality liquidity portfolio that can efficiently hedge liquidity outflows under stress scenarios—that is, to generate sufficient counterbalancing capacity. Since holding standby counterbalancing capacity has an opportunity cost, it is beneficial for banks to hold the minimum cost portfolio that will suffice for hedging out the negative flows.

While one way to build this type of counterbalancing portfolio is to hold affluent cash at hand, this is not optimal for a profit-seeking institution. In general, high liquidity assets, such as cash, are most costly to hold, but are less costly in terms of execution cost when needed to create liquidity.

The computerized planning system disclosed herein utilizes complementary methods of finding an optimal liquidity hedging portfolio that will satisfy regulatory requirements by providing counterbalancing capacity that is sufficient for the bank to be able to remain solvent in at least a specified percentage of stress testing simulation scenarios. The first method involves acquiring more assets that can generate future cash flows to complement the potential net cash outflows. Given a current state of a bank's balance sheet, the financial institution should identify a business plan to grow an investment or asset portfolio that may generate additional future cash flows in a large majority of the projected scenarios. The computerized system uses a linear programming model to perform a first optimization (hereinafter “contractual assets optimization” or “contractual assets portfolio optimization”) that yields the optimal allocation of assets in this portfolio for matching cash out flows in the majority of scenarios. In this process, operational constraints such as percentage limits of a certain asset class that can be selected in the portfolio, can also be applied.

The contractual cash flow matching approach assumes that the assets in the portfolio generate contractual cash flows that naturally complement the liquidity term structure. No active intervention is required at any future horizons. In other words, the computerized liquidity planning system seeks and identifies a portfolio of assets having lowest present value cost amongst all portfolios that have a predetermined counterbalancing capacity such that the net liquidity gap is within the tolerance of the bank and the conditional liquidity at risk (ConLaR) is controlled for each t=1, . . . , T.

The liquidity planning system also uses a second optimization method. This method is applicable when an institution earmarks a dedicated liquidity reserve portfolio (hereinafter the “counterbalancing portfolio”) for deploying additional cash using dynamic counterbalancing capacity through access to credit facilities, asset sales and repo agreements. By properly using the counterbalancing portfolio to access credit facilities and by trading assets in the counterbalancing portfolio as scenarios unfold, an institution can improve its ability to generate liquidity at the exact time when net contractual cash flows from the contractual assets portfolio cannot balance cash outflows.

The counterbalancing portfolio often needs to meet certain operational constraints in order to be recognized by regulators. The institution's objective is usually to minimize the opportunity cost of holding the counterbalancing portfolio while it provides enough cash inflow to hedge cash flow gaps not covered by contractual assets.

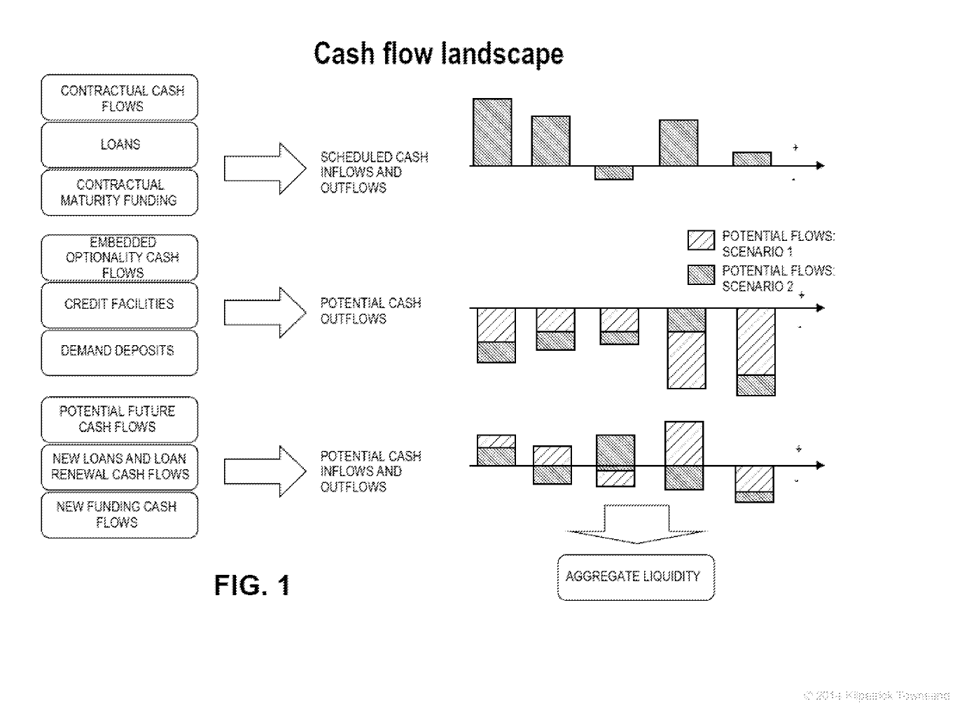

FIGS. 1-11 are used to describe certain generalized operations of the liquidity planning system. However, before these drawings are discussed, this disclosure will present several operational principles, concepts, definitions and notations that may be helpful to understand the operations of the liquidity planning system.

In the analytical and optimization operations performed by the liquidity planning system, the measurement of market and credit risk is based on Value at Risk or other risk measures such as Conditional Value at Risk for a certain time horizon, T. Market and credit risk capital for solvency is monotone across time such that for a given amount of risk capital, solvency at T>t implies solvency at t. The strategy of executing a liquidity hedging portfolio to generate counterbalancing capacity across times, t=1, . . . , T, results in a term structure of liquidity risk across t=1, . . . , T and a path-dependency of liquidity risk such that insolvency happens the first time, t, at which a net liquidity outflow occurs and insufficient hedging capacity is available. The firm may still have sufficient hedging capacity at t+1. However, since that capacity is not available at t, the firm is insolvent. This means that for liquidity risk it is not sufficient to be solvent at T>t if the firm is insolvent at t.

Hereinafter, liquidity risk insolvency will be understood as referring to the first time the risk reserve process, composed of net cash outflows and counterbalancing capacity, turns negative.

### Liquidity Exposure and Solvency

The analysis of liquidity risk performed by the liquidity planning system may be understood in view of certain assumptions. One such assumption is that liquidity outflow is occurring already under a perceived market stress and/or a firm-specific stress. Assuming a comprehensive market and/or bank-specific scenario ω is given on an appropriate probability space (Ω, F, P) such that ωε(Ω, F, P), the bank's aggregate cash outflow of encumbered assets and liabilities can be represented as cf(ω, t). That is the t^{th} net cash outflow (liquidity need) under scenario w. The forward cumulative liquidity need, denoted F, at time t=1, . . . , T is

F(ω,T)=Σₜ₌₁^{T}cf(ω,t). (1)

Here ω denotes a contingent realization of encumbered cash flows such that cf(ω, t) is a stochastic process on the probability space Ω, F, P. The bank's forward cumulative liquidity need, F, accumulates the positive and negative cash flows over time. A positive cash flow at time t is assumed to be rolled over to t+1 and cover any negative cash flows at t+1. This can, happen, for example, if cash at t is put in an overnight account until t+1. The interest rate raised on the overnight account is, however, assumed to be zero. The forward liquidity need at t is composed of the negative and positive cash flows at t, i.e., cf⁻(ω, t) and cf⁺(ω, t) plus the rolled over positive flow from t−1. This gives,

F(ω,T)=Σₜ₌₁^{T-1}cf(ω,t)+cf⁻(ω,T)+cf⁺(ω,T). (2)

If the bank has no liquidity supplying capacity to hedge negative outflows then {F(ω, t)}ₜ₌₁^{T} must be positive for all t=1, . . . , T for survival. This is because a positive F(ω, T) does not help if F(ω, t)<0, with t<T. Hence, liquidity insolvency occurs the first time the process {F(ω, t)}ₜ₌₁^{T} is negative.

FIG. 1 provides a generalized depiction of a bank's liquidity obligations and sources of liquidity funding that are relevant to the liquidity need scenario represented by the immediately preceding formula. Bar charts 111, 112 and 113 represent cash inflows on the positive side of the time axis, and cash outflows on the negative side of the time axis.

The bar chart at 111 is a hypothetical representation of contractual cash flows. Contractual cash flows have a relatively predictable effect on overall cash flow, at least compared to embedded optionality cash flows and potential future cash flows—categories which are depicted at 102 and 103, respectively. Contractual cash flows include loans and contractual maturity funding. Typically, aggregate contractual cash flows are positive for a financial institution, but are sometimes negative when the firm's contractual obligations (e.g., regular interest payments on the bank's debt, dividends to preferred shareholders, salaries, payments on the bank's leases, etc.) during a period exceed its contractual income (e.g., rents on property owned, interest on debt the bank holds, contractual customer service fees, etc.).

Embedded optionality cash flows are less predictable than contractual cash flows. Embedded optionality cash flows result from a bank's customers accessing pre-established credit facilities 105 available at the customer's option, as well as customers' withdrawal of demand deposit funds 106. Example scenarios for future embedded optionality cash flows are represented by the graph 112 in FIG. 1. Because of their variability and unpredictability, the liquidity planning system evaluates potential embedded optionality cash flows using Monte Carlo scenario analysis over a liquidity planning horizon of interest. The Monte Carlo scenario analysis involves multiple economic variables, as will be explained later in this disclosure.

With regard to embedded optionality cash flows, FIG. 1 represents the system's use of Monte Carlo analysis by depicting two different scenario paths. Each of the two scenario paths is depicted along with the effects on embedded optionality cash flows expected to accompany a future that unfolds along the lines described by the scenario. For example, the lower horizontal edges of the magenta bars in graph 112 represent the embedded optionality cash outflows expected to accompany a future that unfolds along the lines described by scenario 1, although a description of scenario 1 is not provided in FIG. 1. Similarly, the lower edges of the blue bars in graph 112 represent the embedded optionality cash outflows expected to accompany a future that unfolds along the lines described by scenario 2.

Potential future cash flows 104 are also less predictable than contractual cash flows. Potential future cash flows 104 can come from new loans and loan renewals in the future, as well as new funding in the future. New funding in the future can include funding from the equity or bond markets, or other sources. Because of the variability and unpredictability of potential future cash flows, the liquidity planning system also applies Monte Carlo scenario analysis to evaluate the possibilities of these cash flows. With regard to embedded optionality cash flows, FIG. 1 the system's use of Monte Carlo Analysis is graph 113 parallels the depiction provided with regard to embedded optionality cash flows in graph 112. However, the graph 113 reflects the fact that potential future cash flows 104 may be either positive or negative at any time period.

In reality, banks hold portfolios of unencumbered liquidity supplying facilities to cover negative cash outflows from {F(∫, t)}ₜ₌₁^{T}. These are the counterbalancing portfolios referred to earlier. For example, the Basel III Accords requires banks to have a portfolio designed to provide counterbalancing capacity. The counterbalancing portfolio of a bank will be represented and conceptualized as U={U(ω, t)}ₜ₌₁^{T}. The optimal choice of the counterbalancing portfolio U is contingent on {F(ω, t)}ₜ₌₁^{T}. That is, for given ωε(Ω, F, P) a portfolio should be chosen that can generate sufficient counterbalancing capacity for hedging out the negative flows of {F(ω, t)}ₜ₌^{T}. However, since in practice, scenarios ω are not known ahead of time, the firm must choose the initial portfolio based on liquidity gap tolerance criteria, such as simulated scenarios and cash flow gaps in these scenarios, and tail constraints based on the liquidity tolerance. Since holding standby counterbalancing capacity has an opportunity cost, the bank maximizes profit by holding the minimum cost liquidity portfolio, U, that is sufficient to hedge out the negative flows of {F(ω, t)}ₜ₌₁^{T}.

Although the most secure liquidity portfolio could consist purely of cash, this allocation generates real losses for a bank. In general, high liquidity assets, such as cash, are most costly to hold (i.e., have a higher opportunity cost) but are less costly in terms of execution cost when needed to create liquidity.

When the liquidity planning system is used to optimize and prescribe the initial endowment of a liquidity portfolio, U, and with the resulting cash flows of this portfolio represented as {U_{f}(ω, t)}ₜ₌₁^{T}, then

U_{f}(ω,t)+F(ω,t)>0 (3)

or

U_{f}(ω,t)≧−F(ω,t) (4)

must be satisfied for all t=1, . . . , T if the firm is to be liquidity solvent at T for any given scenario ωε(Ω, F, P). The first time equation (3) turns negative, the firm faces liquidity insolvency.

In this disclosure, the risk process, R(U, t, Ω) will be understood to be defined such that:

R(U,t,ω)=[U_{f}(ω,t)+F(ω,t)]. (5)

The first stochastic time the risk process, R(U, t, ω), becomes negative is

τ(t,U,ω)=inf(t,R(U,t,ω)<0). (6)

In particular if R(U, t, ω)≧0 for all t, then τ(t, U, ω)=+∞. Additionally, it is important to note that

S=P(τ>T)=P[_{t≦T}^{inf}R(U,t,ω)>0] (7)

such that 1−S(T, U) is the liquidity insolvency probability of the bank. In this liquidity risk setting, the bank is faced with putting limits on {R(U, t, ω)}ₜ₌₁^{T}. That is, the counterbalancing portfolio should not be allocated in a way in which {R(U, t, ω)}ₜ₌₁^{T} would be anticipated to be negative under a plausible ωε(Ω, F, P) for any t=1, . . . , T, or the bank will become liquidity insolvent.

Thus, the liquidity planning system recommends a sufficient counterbalancing portfolio, U, such that a hedging strategy with portfolio U can give rise to sufficient cash flows, U_{f}, to net out the negative outflows from {F(ω, t)}ₜ₌₁^{T}. In this sense, a “sufficient” counterbalancing portfolio, U, means that the portfolio will provide enough liquidity buffer to meet the liquidity needs in order to satisfy the liquidity tolerance, such as, for example, a 99% chance that a bank can survive a $1 billion liquidity shortage. The liquidity planning system is designed so as to choose the minimum cost assets and liquidity facilities that are sufficient for U to provide this counterbalancing capacity, and which do not have significant execution costs when needed to create the liquidity. Execution costs in this respect refer to costs associated with contractual cash flows or cash supplied through the counterbalancing portfolio. For example, cash typically incurs no cost; selling an asset incurs trading costs and possible loss of the value; and repo (repurchasing) agreements, using high quality assets as collateral to borrow money, incur interest.

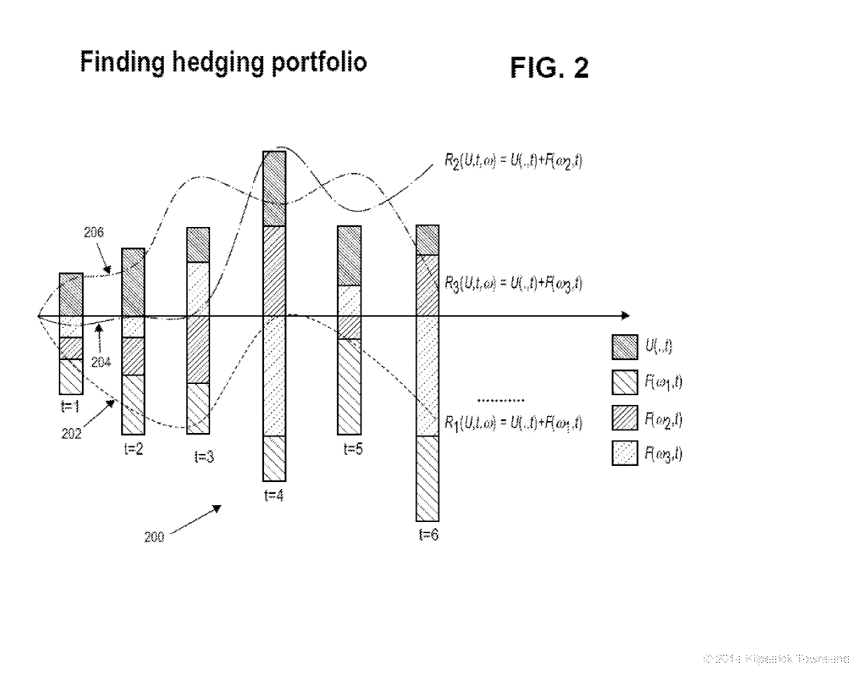

FIG. 2 is a graphical illustration of the scenario described by equations 4 and 5, in which a bank applies a portfolio U for the purpose of generating liquidity to balance cash outflows from {F(ω, t)}ₜ₌₁^{T}. In FIG. 2, negative cash flows at multiple time periods along a liquidity planning horizon are depicted for each of three different scenarios {ω1, ω2, ω3} are depicted. The positive cash flows provided by the hedging portfolio are assumed to be the same for each of the scenarios and are represented by the unshaded rectangles extending above the x-axis. Negative cash flows are represented by the cross-hatched rectangles, with the cross-hatching indicating the correspondence between rectangles and scenarios.

In FIG. 2, lines 202, 204 and 206 represent R(U, t, ω) for the first, second and third scenarios, respectively. Lines 202 and 204 are immediately negative in time period t=1, indicating bank insolvency at this point in time. Conversely, line 206 is positive for all time periods t=1, t=2 . . . t=6. This is an indication of solvency in the third scenario. Assuming that the first, second and third scenarios are randomized Monte Carlo scenarios used for insolvency risk planning, the hedging portfolio represented in FIG. 2 would be expected to remain solvent throughout a six-period planning horizon in only one-third of the possible scenarios.

To manage liquidity risk exposure a firm can put a limit on a risk measure, p, on the distribution of R(U, t, .) for all possible ωε(Ω, F, P) and for all t=1, . . . , T. This limit represents the liquidity risk tolerance. For example, a 99% chance that that risk process, R, is greater than zero means that there is a 99% chance that there is no liquidity shortage after applying the counterbalancing capacity to a contractual portfolio. In one embodiment, a bank will use one risk measure, ρ, such as, for example, Value at Risk or Conditional Value at Risk as described further herein; however, the measure may be applied to all of the periods in a planning horizon. A firm that utilizes the limit must then manage the assets of the counterbalancing portfolio such that sufficient counterbalancing capacity can be generated, ensuring that the risk measure, ρ, of the distribution of R(U, t, .) satisfies the limit, λₜ, for all t=1, . . . , T. The liquidity hedging optimization models used by the liquidity planning system and described in this disclosure are consistent with such management of liquidity exposure.

### Liquidity Risk Measures

Following the definition of liquidity exposure and solvency, the standard tail risk measures such as Value at Risk and Conditional Value at Risk can be extended to the liquidity risk process, R(U, t, ω), for a given t, in equation (5). Of course, known risk measures other than Value at Risk and Conditional Value at Risk may also be used. These risk measures may be linear or non-linear. To explain the framework of the liquidity planning system, the use of the Value at Risk measure in the context of the framework will be referred to hereinafter as Liquidity at Risk (LaR) such that LaR, in the context of the counterbalancing portfolio, can be defined as

LaR(α,t)=VaR[R(U,t,.)]. (8)

In the optimizations performed by the liquidity planning system LaR(α, t) is constrained to be nonnegative (liquidity solvent) at every risk horizon t=1, . . . , T with probability 1−α, where α is between 0 and 1. For example, for a 99% chance of nonnegative gap, α is 0.01 or 1%. Similarly, the Conditional Value at Risk measure for the risk process in equation (5) is denoted Conditional Liquidity at Risk (ConLaR), with probability 1−α. ConLaR it can be defined as

ConLaR(α,t)+∫_{R(U,t,ω)≦LaR(α,t)}R(U,t,ω)p(ω)dω. (9)

ConLaR is a coherent risk measure that behaves better than LaR in optimization problems. It is also a more conservative measure than LaR. For this reason, the liquidity risk planning system uses ConLaR as a constraint for the liquidity risk process, R(U, t, ω), for a given t.

### Optimal Liquidity Hedging Portfolio Strategies

Of course, it is not advisable for a bank to hold a contractual asset portfolio that is certain to cover cash outflows in all scenarios, since such a portfolio would be so heavily devoted to cash that the bank would incur real losses over time. Additionally, with the banking innovations of the recent decades, and the complexity of embedded optionality in banking products such as deposits and credit facilities, it is an especially complex exercise to arrange a portfolio of contractual assets that, by itself, will provide natural complementing flows under liquidity stress.

Thus, a contractual asset portfolio should neither be structured nor expected to actually cover a bank's net cash outflows in the event of any possible scenario.

A more informed approach is to select the lowest cost contractual assets portfolio that, when stress tested, is evaluated as capable of providing complementary cash flows in at least a specified percentage of Monte Carlo testing scenarios. The specified percentage can be selected to comply with regulatory requirements without exceeding the bank's tolerance for risk.

The liquidity planning system uses this approach, and takes a percentage parameter as an input, as well as numerical inputs that represents a planning horizon. The percentage parameter represents a minimum acceptable percentage of Monte Carlo simulation paths over which the cash inflows provided by the contractual assets must be forecasted to cover cash outflows throughout the planning horizon. The liquidity planning system determines and prescribes the lowest cost portfolio that satisfies this criteria, and prescribes the assets and their allocation so that the portfolio may be implemented.

Because the contractual assets portfolio recommended by the liquidity planning system is not intended to be capable of providing complementary cash flows in all Monte Carlo testing scenarios, the liquidity planning system also prescribes how to leverage counterbalancing capacity through strategic commitment and asset acquisition in order to supply liquidity at the exact time when net contractual cash flows cannot balance bank obligations. Counterbalancing capacity (CBC), as described previously, refers to the liquidity that a firm is expecting to be able to access over a given timeframe to fund a liquidity gap. By identifying a lowest cost (e.g., profit maximizing) counterbalancing portfolio that is appropriate in view of a bank's risk tolerance, obligations and contractual assets, the liquidity planning system prescribes a reliable way for a bank to mitigate unexpected liquidity gaps in relatively severe scenarios.

In selecting the counterbalancing portfolio, the liquidity planning system uses a second optimization process that finds a minimal cost (e.g., profit maximizing) strategy to meet the hedging requirements of this portfolio. The liquidity planning system can optimize either the contractual assets portfolio or the counterbalancing portfolio, or can employ the approaches jointly, as desired by bank management, based on the bank's operational, competitive and financial status. However, because the two approaches are complementary, this disclosure will describe how the risk planning system chooses assets, credit facilities and their allocation in the counterbalancing portfolio when a contractual assets portfolio has already been established.

Regardless of whether a bank uses the liquidity planning system to hedge with contractual assets, counterbalancing capacity, or both, the liquidity management system solves for lowest cost assets to meet the bank's risk objectives. The liquidity planning system takes an input (A) that represents the liquidity supplying facilities to which the bank has access, and an input that represents the multi-period (daily, weekly, monthly, annually, etc.) planning horizon t=1, . . . , T in which the bank is interested. Based on these inputs, the liquidity planning system seeks to identify a liquidity hedging portfolio U made of a subset of facilities in A so that the risk process R(U, ω, t) can be prevented from being negative at every time period between t=0 and t=T. The liquidity planning system selects a liquidity hedging portfolio that bears minimal up-front cost,

min Σ_{iεA}xᵢVᵢ (10)

where Vᵢ is the value of liquidity hedging asset i and xᵢ its share, so that

ρ[R(U,t,.)]≧λₜ t=1, . . . , T. (11)

Here, the constraint, {λₜ}ₜ₌₁^{T} is set on a horizon-by-horizon case. The constraint can be negative at certain periods, provided that an extra cash buffer is available. When the risk measure, ρ, is equal to Conditional Value at Risk (which in this setting is denoted the Conditional Liquidity at Risk, i.e., ConLaR) then in a one-period portfolio optimization context, Conditional Value at Risk can be approximated with a set of k=1, . . . , n simulated scenarios. The liquidity planning system applies a multi-horizon cash flow mismatch optimization model with Conditional Value at Risk constraints that can be used to approximate ConLaR(α, t) in equation (9) as

$$ConLaR ( α , t ) = - {γ}_{t} + \frac{1}{α n} {\sum }_{k = 1}^{n} {[ - {R}^{k} ( t ) + {γ}_{t} ]}^{+} . \qquad ( 12 )$$

In equation (12) α is the liquidity solvency probability, γₜ is a deterministic parameter dependent on t=1, . . . , T, and, R^{k}(t) is the kth realization of the risk process, R, in equation (5) at time t. Here, we have also used the notation,

$${[ x ]}^{+} = \begin{matrix}x & if x > 0 \\ 0 & otherwise .\end{matrix} \qquad ( 13 )$$

This approach is separately applicable to both the counterbalancing capacity optimization model and the contractual assets optimization model, described further herein. Between these models, however, α and ConLaR(α, t) can be different. Due to the presence of cash flows at multiple horizons, and the need to ensure liquidity solvency at all t=1, ; . . . , T, traditional one-period portfolio optimization is not adequate to solve the problem.

### Hedging with Contractual Cash Flows

The optimal contractual assets portfolio model that the liquidity planning system uses is based on the replicating portfolio approaches used in risk management and asset pricing. This approach builds on classical portfolio immunization in asset and liability management. For liquidity risk, the liquidity planning system achieves immunization by directly matching cash flows through finding the minimum cost contractual assets portfolio that matches the negative cash flows of F(ω, t) of the bank's balance sheet and business operations. This liquidity planning system performs this matching using a linear programming model that finds a minimal cost replicating portfolio that generates enough cash flow to constrain the mismatched cash flows over a given planning horizon to meet a set of risk measures that are based on criteria such as Conditional Value at Risk constraints.

For the purposes of the following explanation, assume that each liquidity facility i in the contractual assets portfolio has a cash flow stream U_{f}ⁱ(ω, t) at time t=1, . . . T, and in a simulation, scenarios ωₖ, k=1, . . . , n comprise sample space of (Ω, F, P). Using the notation in equation (5) and the approximated ConLaR in equation (4) in a simulation, the liquidity planning system finds the contractual assets portfolio that satisfies the following objective and constraints:

$$min \frac{1}{n} {\sum }_{k = 1}^{n} [ {\sum }_{i ∈ A}^{ } {x}_{i} {V}_{i}^{k} ] \qquad ( 14 )$$

for every time horizon t, subject to

$$\begin{matrix}\frac{1}{n} {\sum }_{k = 1}^{n} {R}_{t}^{k} \geq 0 , & ( 15 ) \\ {R}_{t}^{k} - {γ}_{t} + {z}_{t}^{k} \geq 0 , \\ {z}_{t}^{k} \geq 0 , & ( 16 ) \\ {γ}_{t} - \frac{1}{α n} {\sum }_{k = 1}^{n} {z}_{t}^{k} + {λ}_{t} \geq 0 & ( 17 )\end{matrix}$$

where the constraint in equation (15) ensures that the expected net cash outflow is positive, and, the remaining constraints are controlling ConLaR. The introduction of the auxiliary variable, zₜ^{k}, facilitates writing the non-linear ConLaR constraint as a series of linear constraints. Specifically, constraint (16) and (17) are rewritten from

$$\begin{matrix}{z}_{t}^{k} \geq - {R}_{t}^{k} + {γ}_{t} \\ and & ( 18 ) \\ - {γ}_{t} + \frac{1}{α n} {\sum }_{k = 1}^{n} {z}_{t}^{k} \geq {λ}_{t} & ( 19 )\end{matrix}$$

respectively. In these constraints,

Rₜ^{k}(x)=Σ_{iεA}[xᵢCFᵢₜ^{k}+Fₜ^{k}] (20)

where Fₜ^{K} is the forward liquidity exposure at t for scenario k and CFᵢₜ^{k} is the contractual cash flow at t from instrument i in scenario k. The liquidity planning system determines forward liquidity exposure (Fₜ) by the cash flow aggregation of existing contracts as well as any new anticipated contracts during the funding liquidity horizon, t=1, . . . , T. The liquidity planning system includes new potential cash flows because, for example, a firm is expected to continue to serve new loans and renew loans with contractual maturity to some extent even in liquidity distress. A subset of the existing contracts typically have embedded optionality such as potential cash flows associated with deposit withdrawal and credit facility utilization. Such embedded optionality features are the main reason for the aggregated forward liquidity exposure, Fₜ, to change across scenarios. In addition, the projected new contracts may depend on the scenario.

The liquidity planning system determines assets for the contractual cash flow matching portfolio so that the assets will generate contractual cash flows that naturally complement the liquidity term structure without trading or portfolio reallocation. Thus, no active intervention is required at any future horizons. In other words, the liquidity planning system solves for a portfolio of assets with the lowest present value cost (as expressed in equation (14)) that have a pre-determined contractual cash flow such that the net cash outflow is within the tolerance of the bank as in equation (15) while the Conditional Liquidity at Risk, ConLaR, is controlled, for each t=1, . . . , T at certain levels, {λₜ}ₜ₌₁^{T}. Note that this case can also happen if a liquidity hedging strategy for converting assets into cash is pre-determined, i.e., if the contractual cash flow strategy is pre-determined at the present time. Of course, the model may not only be used to find the optimal liquidity hedging cash flows given a firm's current situation for forward liquidity exposure, Fₜ. The liquidity planning system can also use the model to optimize a firm's strategic liquidity balance sheet more generally by experimenting with the selection of cash flows in the forward liquidity exposure.

### Hedging with Counterbalancing Capacity, the Counterbalancing Portfolio, and the Counterbalancing Model for Portfolio Allocation and Trading

The counterbalancing model assumes active management during the horizon, t=1, . . . , T, to mitigate the net cash outflows. Contractual cash flows, e.g., dividend, coupons, and embedded options, carry more uncertainty due to the increasing complexity in the banking products. Banks must therefore manage liquidity risk more diligently. When the cash flows from the underlying portfolio change unexpectedly from horizon to horizon, a portfolio model that recognizes the opportunity for dynamic borrowing and sales will appropriately reflect the extra liquidity generation through counterbalancing capacity.

Counterbalancing capacity comes from the asset buffer that can be converted into cash flow via sale, repo or renewal of borrowing. Dynamic hedging with counterbalancing capacity compensates for the shortfalls of hedging with cash flows from the contractual assets portfolio. For example, contractual hedging is limited by the acquisition capability of a bank.

Not all liquidity risks can be hedged based on core contractual business using cash flows that naturally complement the outflow. Thus, the liquidity planning system prescribes a lowest cost counterbalancing portfolio and decisions for proactively managing the portfolio ahead of liquidity stress events. By implementing the counterbalancing portfolio and managing the portfolio assets as prescribed by the liquidity system, a bank can minimize the residual liquidity risk that cannot be eliminated using contractual assets by themselves.

To define the dynamic counterbalancing based model of optimal liquidity hedging, it is helpful to review the two major types of dynamic liquidity facilities used to generate counterbalancing capacity. These two facilities are contingent credit facilities and assets.

A credit facility may explicitly or implicitly require an up-front fee. The liquidity planning system assumes this fee is relative to the facility limit L, that is βL. The choice of facility limit L is subject to a cap l that is set by the facility creditor. Here, l is the maximum limit the counterparty offers and L is the limit applied for by the firm. This means that L≦1 as the firm may choose not to use all the available facility as there is a fee associated with the limit. Most facilities are revolving at the preset limit L and the facility balance is between 0 and L. The drawn portion of a credit facility is subject to an interest rate charge, r, that is also included in the outstanding balance of the facility at the time. At any time t, a cash flow bₜ can result from the credit facility. It can be either a drawn amount (positive contribution) or a payback amount (negative contribution). The cash contribution at time t is bₜ, while the balance of the facility is B_{i,t}+B_{i,t-1}rₜ₋₁ which is between 0 and L where Bₜ=Σₛ₌₁^{t} bₛ. A negative balance is not possible at any time, that is Bₜ≧0.

A firm can acquire x shares of a tradable, unencumbered, security at time t for liquidity hedging purpose. The price of acquisition is xSₜ with Sₜ the asset price which includes the trading cost and x the number of shares. In this model, we disallow short sale of any security, that is, x≧0. A limit, Xⱼ, can also be imposed on the position of a security j such that xⱼ≦Xⱼ. Cash can be viewed as a special security with constant value through the entire planning period. Usually, only high quality securities are considered to bear stable liquidity supplying capacity in liquidity stress. For example, Basel III (2010) effectively restricts the eligible instruments for the managed liquidity hedge portfolio to level 1 and level 2 assets where the cap on level 2 assets in the pool of liquidity hedging instruments is 40%.

Level 1 assets have a zero haircut and include, for example, cash, central bank reserves, and premium government and municipal bonds. Level 2 assets have a regulatory haircut of 15% and include for example high quality corporate and covered bonds. A security can meet the liquidity need in two ways. Firstly, it can be sold at the prevailing market price, assuming the volume of the sales is within market depth, v, to avoid excessive loss. Clearly, the cost of acquiring the counterbalancing capacity is not the only measure of cost. When the liquidity supplying assets are needed to convert to cash to hedge negative outflows, the firm pays liquidity execution costs. Such liquidity execution costs can be very high in the midst of a financial turbulence, and hence, the actual cash value of liquidity assets as well as the best execution strategy should be taken into account when selecting U. At planning time, the objective is to construct a strategy such that a fire sale can be avoided in any future horizon. This can be done by setting ex ante projected sales to be bounded under the projected market depth of the asset in a scenario.

The second way of obtaining cash from an asset is to use it for a collateralized borrowing, typically through a repurchase agreement (repo) contract. At any time t, δxₜ shares of a security can be traded. When liquidity is needed, a portion of an asset can be sold. Similarly when the underlying portfolio has a cash surplus, a portion of the asset can be bought back. The total cash flow from the trading is δxₜSₜ which includes trading cost. To avoid short selling of an asset, the liquidity planning system evaluates two legs of trading: y₋ is sale (positive cash contribution) and y₊ is purchase (negative cash contribution). The cash flow from trading can be expressed as (y_{-,t}−y_{+,t})Sₜ. Both y_{-,t} and y_{+,t} must be nonnegative, i.e., y_{-,s}≧0 and y_{+,s}≧0.

When executing the counterbalancing model, the liquidity planning system can also constrain the sales according to the market depth such that y_{-,t}≦vₜ, where vₜ is the market depth proxy at time t. The separation of the two trading legs also makes the trading cost incorporation an easy extension to the model. If a security is repo'ed, this disclosure denotes the repo'ed share of a security as q. The shares to be used as collateral in repo contracts can be controlled by setting a limit Q. For example, Q is set to zero for a cash asset as it is not a repo instrument. The actual contribution to the cash flow from repo at time t is qₜSₜhₜ, where hₜ is a haircut to the collateral. The counterbalancing portfolio model can be operated so as to assume that all securities can be accepted for repo at any time. However, there may be a significant haircut.

The liquidity planning system may also operate the model under the assumption that an existing repo can be rolled over. Hence, qₜ≧0. Except for an initial endowment to acquire certain assets, the entire hedging strategy is self-financing without further cash flow injection. Any liquidity providing asset can be sold, repo'ed and replenished at any time. Therefore, a constraint used in the counterbalancing portfolio model is that at any time t, the total traded and repo'ed shares of the asset are not more than the initial endowment of the asset. That is,

x−Σₛ₌₁^{t}(y_{-,s}−y_{+,s}+qₛ)≧0. (21)

A security can also generate coupon or dividend income based on the number of shares held at that time. Operations of the counterbalancing portfolio model assume the encumbered portion also contributes to this income as the firm still owns the portion. Assuming coupon or dividend rate is e, this cash income is thus the current holding of the asset multiplied by the income rate, e. That is, at time t,

[Σₛ₌₁^{t}(y_{+,s}−y_{-,s})+x]eₛ (22)

The optimal counterbalancing portfolio is a minimal cost liquidity supply portfolio that has an active counterbalancing capacity to meet liquidity need. Because of the dynamic counterbalancing activity in this model, the point in time liquidity cash flow gap is used as input. For example, in the case of hedging with counterbalancing capacity, the contractual cash flows (either as the result of the optimal contractual liquidity hedging or the current bank portfolio) are used as input, with the goal of planning the counterbalancing portfolio and execution strategy to meet the liquidity tolerance criteria. When there is a positive cash flow gap, the optimized rebalancing activity should use it to refresh the liquidity inventory by either paying back a borrowing or buying additional assets depending on what is optimal for that specific simulation, k, and path, t=1, . . . , T. The cumulative liquidity gap nature of the model is hence implicitly built into the dynamics. Subscript i=1, . . . , I are applied to credit facilities and subscript j=1, . . . , J to asset securities in the model. The firm minimizes the cost of obtaining the liquid funds such that

$${min}_{i , j ∈ A} {β}_{i} {L}_{i} + {x}_{j} {S}_{j} , \qquad ( 23 )$$

subject to balance and cash flow conditions. The balance and boundary conditions are for each t=1, . . . , T, j=1, . . . , J, i=1, . . . , I and k=1, . . . , n. Firstly, for the facilities we have that,

Lᵢ≧0, (24)

Lᵢ≦lᵢ, (25)

i.e., the facility limit, Lᵢ, applied for facility i is greater than or equal to zero and less or equal to the creditor offered limit, lᵢ. The balance of the facility is moreover between 0 and L and is therefore constrained from being negative:

Lᵢ−[B_{i,t}^{k}+B_{i,t-1}^{k}rₜ₋₁^{k}]≧0, (26)

B_{i,t}^{k}+B_{i,t-1}^{k}rₜ₋₁^{k}≧0, (27)

B_{i,t}^{k}≧0 (28)

The asset j holding conditions include a non-negative holding constraint against short-selling. The holding for asset j can also be subject to a limit, Xⱼ,

xⱼ≧0, (29)

xⱼ≦Xⱼ (30)

The sum of asset j holding purchase, sales and repo'ed shares are not to be more than the initial holding of asset such that

xⱼ−Σₛ₌₁^{t}(Δxⱼₛ^{k}+qₛ^{k})≧0 (31)

where Δxⱼₜ^{k}=y_{j-,t}^{k}+y_{j+,t}^{k} is the net change of the asset holding at time t. There are also regular asset j buy and sell constraints, and asset j sell portion cannot exceed the market depth, vⱼ

y_{j-,t}^{k}≧0 (32)

v_{j,t}^{k}−y_{j-,t}^{k}≧0 (33)

y_{j+,t}^{k}≧0 (34)

Finally, the repo portion is greater than or equal to zero for an asset j, but can be capped by an upper limit which can be different at different horizons,

q_{j,t}^{k}≧0 (35)

q_{j,t}^{k}≦Q_{j,t} (36)

Similar to the contractual assets portfolio optimization model, using the auxiliary variable z, the constraint for expected net cash outflow being positive and the constraints controlling ConLaR are:

$$\begin{matrix}\frac{1}{n} {\sum }_{k = 1}^{n} {\tilde{R}}_{t}^{k} \geq 0 , & ( 37 ) \\ {\tilde{R}}_{t}^{k} - {γ}_{t} + {z}_{t}^{k} \geq 0 , & ( 38 ) \\ {z}_{t}^{k} \geq 0 , & ( 39 ) \\ {γ}_{1 , t} - \frac{1}{ α n} {\sum }_{k = 1}^{n} {z}_{t}^{k} + {λ}_{t} \geq 0 , \\ where & ( 40 ) \\ {\tilde{R}}_{t}^{k} ( x , L ) = ( {\sum }_{i = 1}^{I} {b}_{i , t}^{k} ) + {\sum }_{j = 1}^{J} [ \begin{matrix}Δ {x}_{jt}^{k} {S}_{jt}^{k} + {q}_{jt}^{k} {S}_{jt}^{k} {h}_{jt}^{k} + \\ ( {\sum }_{t = 1}^{t} Δ {x}_{jt}^{k} ) {e}_{jt}^{k}\end{matrix} ] + {F}_{t}^{k} . & ( 41 )\end{matrix}$$

Here, \tilde{R} is the point of time cash flow instead of the cumulative cash flow, R.

The counterbalancing portfolio model finds an optimal initial endowment for a counterbalancing portfolio that can cover liquidity risk on target horizons. In addition, it details the counterbalancing trading strategy on each simulated path by the optimal selection of the cash flow from a credit facility, b, asset buys, y₊, asset sales, y₋, and, repo portion q at each simulation state k=1, . . . , n and horizon t=1, . . . , T. The model provides liquidity hedging decision makers with the complete hedging strategy for realized scenarios k=1, . . . , n across horizons, t=1, . . . , T. The model is also conservative in the sense that it controls liquidity at every future horizon covered in the analysis, i.e., it controls liquidity at each t=1, . . . , T. As will be seen in the application discussion, the model also produces intuitive results for the optimal initial endowment portfolio that are consistent with the Basel III regulatory requirements on requiring high quality assets for firms liquidity hedging portfolios.

This disclosure will now explain the components and operating environment of the liquidity planning system, and will then, incorporate flowcharts and system diagrams to provide a generalized overview of the computerized operations performed by the liquidity management system.

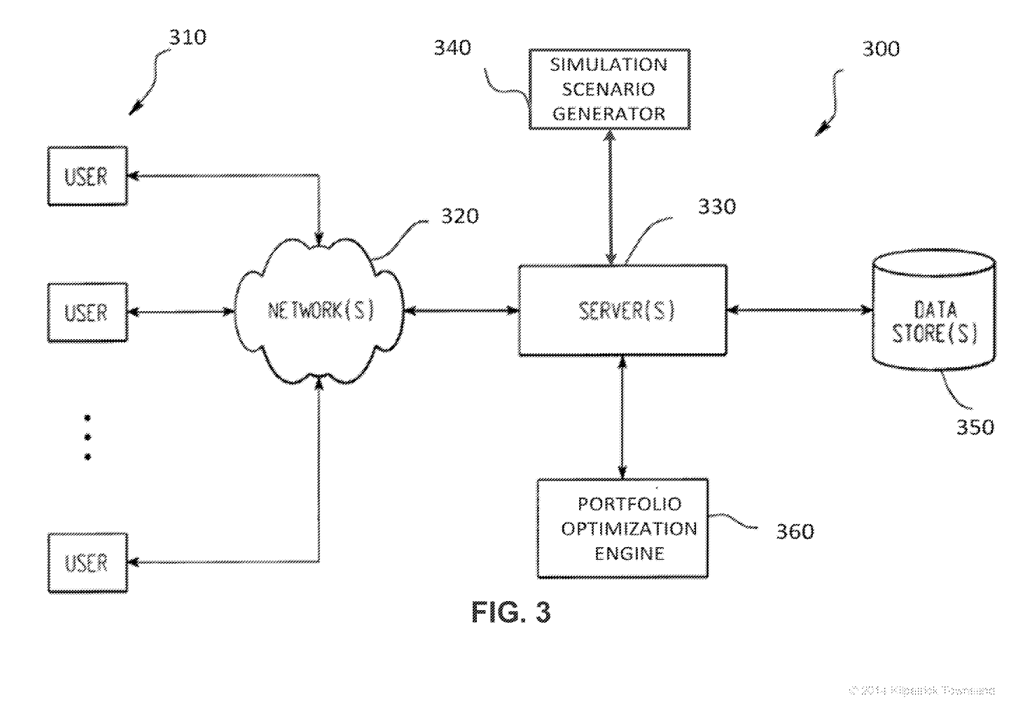

FIG. 3 depicts is a block diagram that provides a generalized illustration of hardware and software components of an example liquidity management system 300. The liquidity management system may be built around one or more servers 330 that provide the computing power necessary to perform portfolio optimizations for a bank's contractual assets portfolio and counterbalancing portfolio.

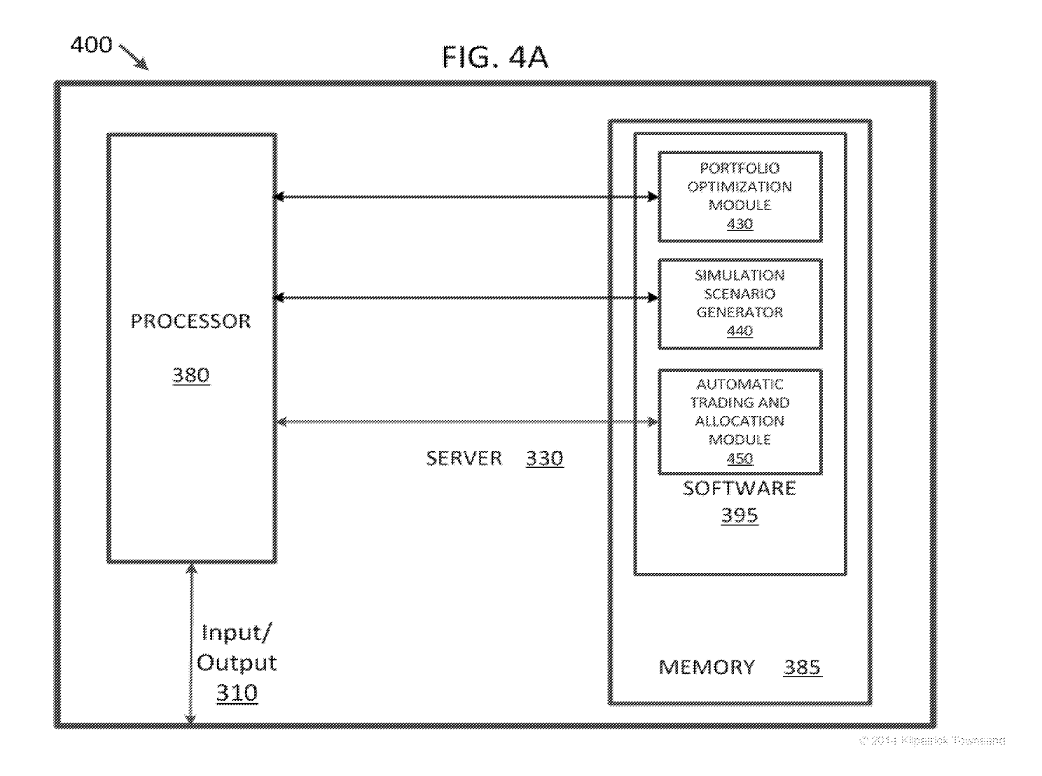

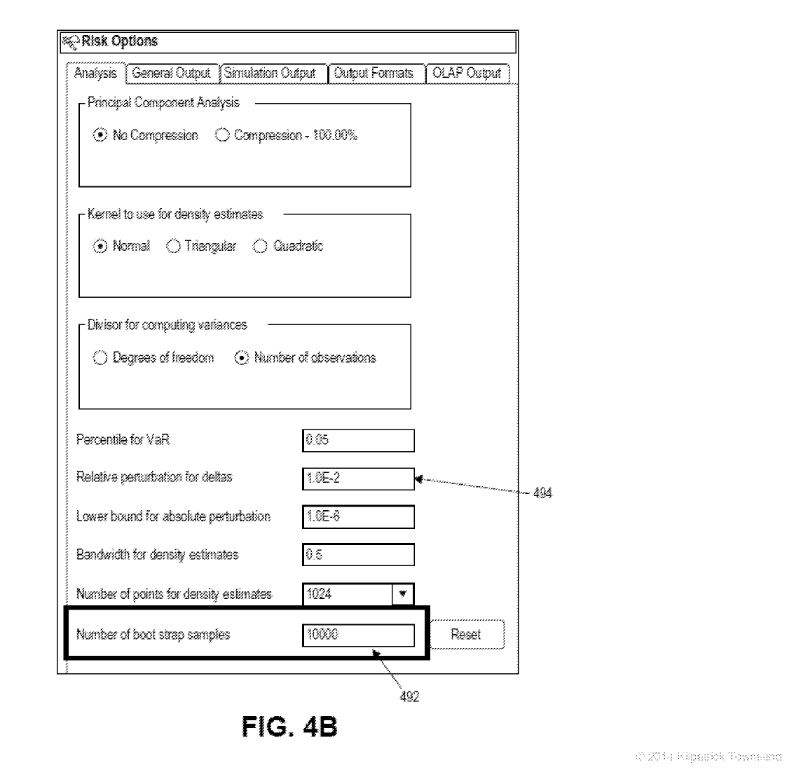

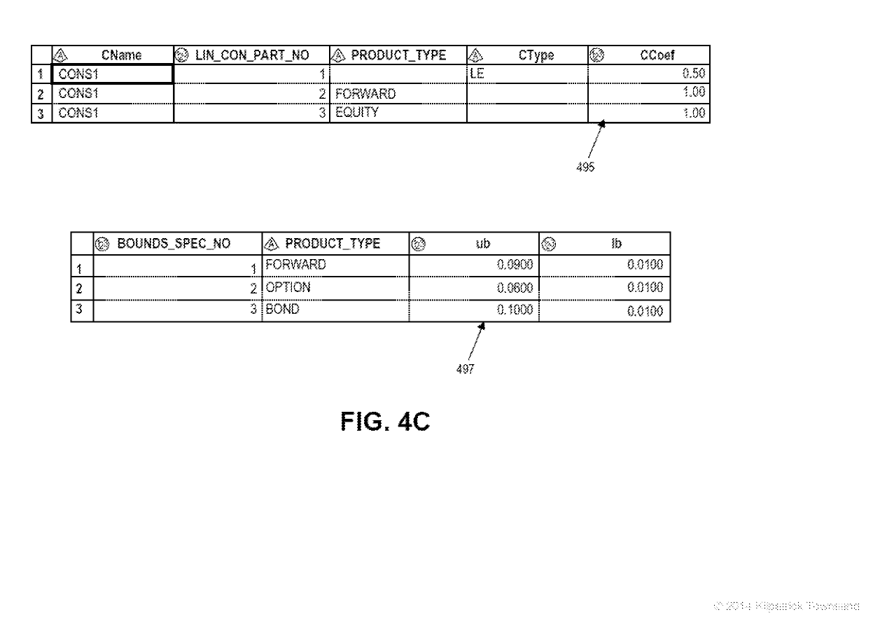

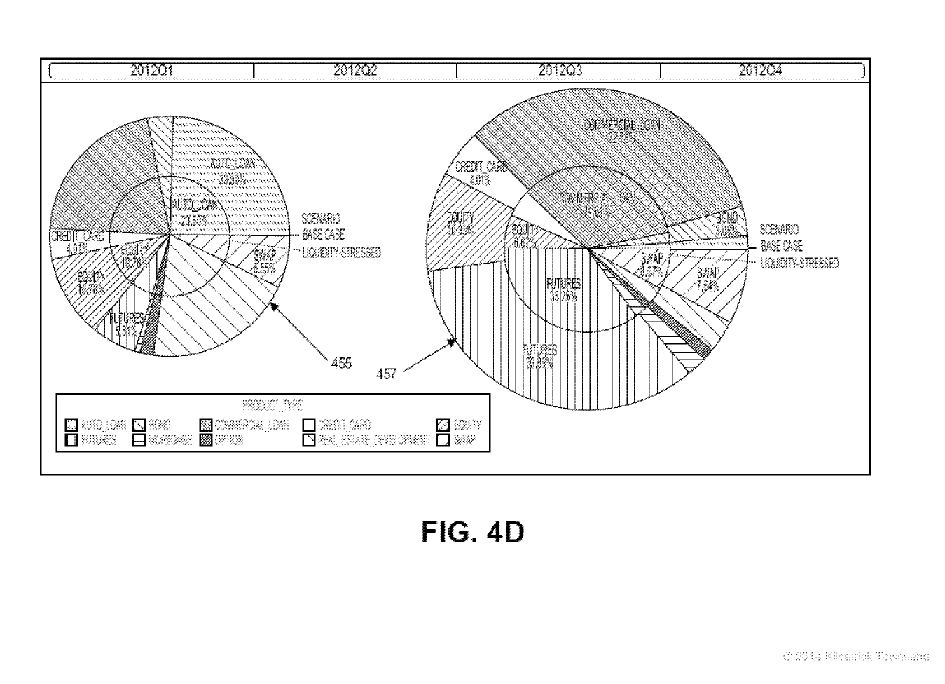

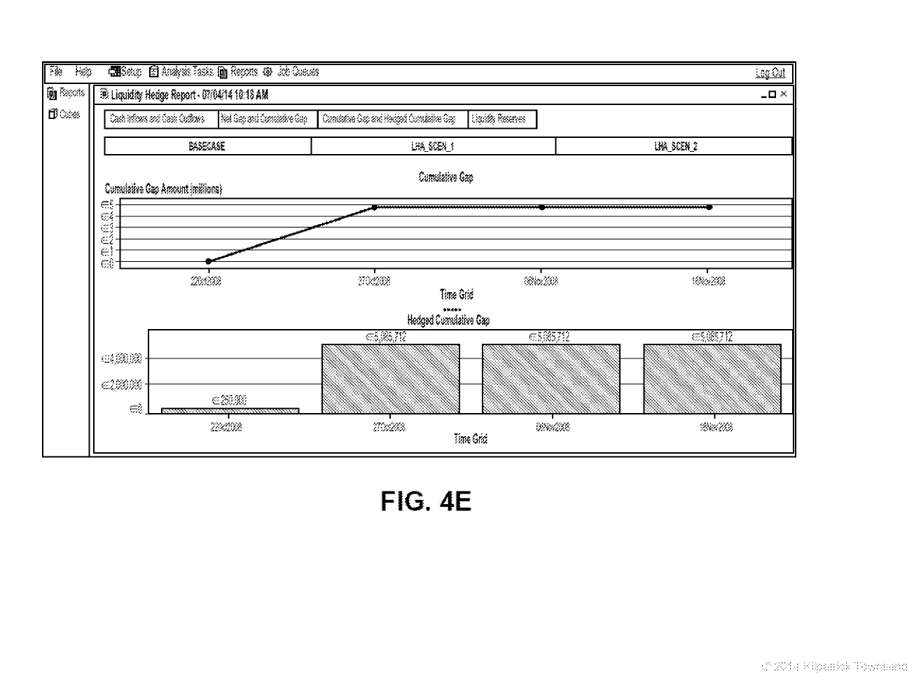

One example server is depicted in FIG. 4A. The servers 330 may include any number of processors 380, any number of which may be multi-threaded. The servers 330 also include a memory 385 and software 395.

The software 395 includes a portfolio optimization module 430 having instructions for implementing both the contractual assets model and the counterbalancing capacity optimization models that were described previously. A scenario simulation generator 440 includes instructions for performing randomized simulations of the results of using the portfolios identified by the models to hedge liquidity risk. The software 395 also includes input/output instructions that are used by the server 330 to solicit and obtain from a user the various inputs, parameters and constraints used by the models. This information includes parameters such as the cost of using particular credit facilities and upper limits on the money made available by the facilities, the liquidity planning horizon and the duration of the time period intervals to be evaluated on the horizon, interest rates of the various bonds and other investments, haircut rates, asset buy and sell constraints, market depth assumptions, and any of the other parameters or constraints mentioned above the description of the optimization models.

An automatic trading and allocation module 450 includes instructions for accessing large amounts of data, such as banks' asset and liability data, as well as liquidity hedging portfolios and economic and market data. This data may be available online or over a network, or locally in memory 385. The liquidity management system 300 is able to automatically implement the portfolio allocations that it recommends, monitor scenarios as they develop, and trade and manage a bank's counterbalancing portfolio following the conclusion of each time period of a liquidity planning horizon on a large scale. The liquidity management system can also access multiple interbank lending portals and credit facilities to initially endow a portfolio or automatically trade the portfolio following the conclusion of each period on a liquidity planning horizon.

The server 330 uses an input/output capability 310 to store and retrieve data from data store 350. Data store 350 is used to store data used by the system in simulating the results of holding the liquidity hedging portfolios (contractual assets portfolio and counterbalancing portfolio) and making the trading decisions that the system identifies. This data includes a wide variety of historical financial and economic data, as well as information about the bank's balance sheet and business environment that can be inputted by a user.

The data store 350 also holds recent and historical data about credit markets, the economy and the financial status of the bank's customers. The economic data includes historical time series data with regard to economic variables such as oil prices, unemployment, stock market performance, GDP, tax revenues, inflation, Treasury rates, etc.

The data also includes information about default rates and performance of various classes of bonds, equity, real estate and other investments available to the financial institution or bank that is using the liquidity planning system. This performance information details historical changes in the cash flows yielded by these instruments at various times for which economic data is available.

Also, historical financial institution data is included in the data store 350. The financial institution data can be in the form of time series data or correlation data, or both. Financial institution data includes the historical changes in the bank's negative and positive cash flow throughout its history. For example, the financial institution data shows changes in the bank's depositor withdrawal rate, new deposits, and changes in cash flows attributable to imbedded optionality, as well as other forms of obligations. When the financial institution data is stored in the form of correlation data, the correlation data may indicate the correlation between the various forms of negative cash flow and other variables tracked within the data store. For example, the correlation data may include historical correlation of the deposit withdrawal rate with GDP, as well as with the price of oil, the unemployment rate and any of the other variables tracked in the data store 350.

The liquidity management system 300 uses the economic and investment data in the data store 350 to compute correlations between economic variables and the cash flows of the various investments and instruments available to the bank. The liquidity management system 300 also uses the economic and investment data in the data store 350 to compute correlations between economic variables and the various categories of outgoing cash flow demands that the bank can face. By computing these many correlations, the liquidity planning system 300 is able to randomly generate multitudes of simulated economic scenarios as part of a scenario analysis that uses Monte Carlo simulation techniques.

Each simulated economic scenarios involve a specified balance sheet condition of the bank as a starting point which is followed by a series of hypothetical changes of a specified magnitude in significant micro-economic, macro-economic, and political variables, with changes occurring at each time period on the forecast horizon. For each of these scenarios, the system 300 uses the correlation data that relates economic variables, investment variables, and financial institution variables, and forecasts a series of cash flow changes that would be occasioned if the scenario were to come to fruition.

When the liquidity planning system 300 uses the contractual assets model or the counterbalancing model to identify a lowest cost contractual assets or counterbalancing portfolio, financial decision-makers, risk managers, or other users can then operate the system 300 to perform and analyze a Monte Carlo simulation of the bank's cash flow and liquidity condition when the portfolio is used. To perform a Monte Carlo simulation, the liquidity planning system activates the simulation scenario generator 440.

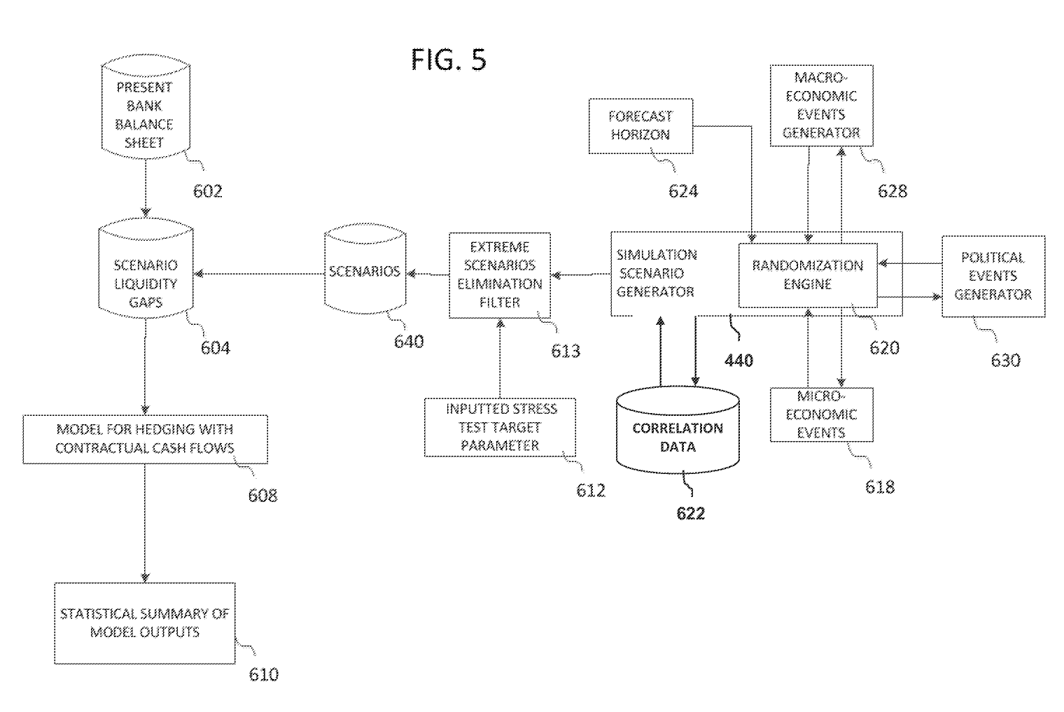

The simulation scenario generator 440 includes a random number generator capable of quickly generating large quantities of random numbers. The simulation scenario generator 440 may receive historical events distribution data from a political events generator 630, a micro-economic events generator 618 and a macro-economic events generator 628, as shown in FIG. 5.

Based on statistical distributions of the variables represented by the economic data, financial institution data and investment data, the simulation scenario generator 440 maps each of the random numbers to a value of each of these variables, and uses the values to create multiple scenarios. For example, any number of the scenarios could involve a series of GDP changes over a multi-quarter, or multi-year period. Scenarios can also involve changes with respect to variables such as tax rates, oil prices, employment rates, inflation, interest rate benchmarks, and any other significant economic or political factor.

After the simulation scenario generator 440 has established scenarios in this way, it accesses information about the contractual assets and counterbalancing portfolio allocations (also referred to previously as “initial endowments”) identified using the contractual assets and counterbalancing models. The simulation scenario generator 440 also accesses correlation data from a data store 622. The correlation data and scenario information is then used to determine the cash flow impacts resulting from the changes affecting the simulation variables from one period to the next.

When a simulation is executed, the liquidity planning system outputs a graphical display (not depicted) of the simulation results. The liquidity planning system 300 outputs the display by using network 320 to download display data and executable code from server 330 so that the data and code may be executed and/or processed at any of the user terminals 310.

This graphical display (not depicted) can provide a range of interactive data analysis capabilities. For example, the graphical display may include functionality that enables a user to examine specific scenarios or groups of similar scenarios, and view a histogram or other statistical data regarding the financial implications (e.g., cash flow, liquidity, etc.) accompanying the simulated scenarios. As another example, a user may wish to examine a range of scenarios specified with regard to the financial results simulated in the scenarios. For example, a user may wish to examine a specified number or percentage of the scenarios that were associated with the highest variation in cash flows during the simulation. The liquidity planning system 300 may provide functionality on the graphical display so that the user may specify this type of criteria and be presented with distributional data or other statistics that summarize or depict the results.

The graphical display may also provide functionality that enables a user to control the generation of simulation scenarios. For example, FIG. 4B is a screenshot from a graphical display that shows one example of this type of functionality. At 492, an input window enables a user to input a number of simulation scenarios to be generated. Additionally, at 494, another input window enables a user to input and establish a risk parameter that will be described later.

The graphical display may also provide functionality that enables a user to control the constraints provided to the contractual cash flows optimization model and/or the counterbalancing optimization model. FIG. 4C is a screenshot from a graphical display that shows one example of this type of functionality. At 495, an input window enables a user to input portfolio allocation constraints that limit the portion of a portfolio that can be allocated to equity and forward contracts. The constraint at 496, which limits the value of equity and forward contracts to 50% of a portfolio, can be implemented by inputting the series of coefficients shown at 495.

At 497, a second input window enables a user to input additional portfolio allocation constraints with regards to individual classes of assets. For example, in the column labeled “ub”, a user can provide inputs in order to place upper bounds on the percentage of a portfolio that may be composed of forward contracts. Similarly, the user can provide inputs to place upper bounds on the percentage of a portfolio that may be allocated to options, and the percentage that may be allocated to bonds. In the same fashion, a user can input lower bonds on each of these allocations. This can be done by inserting numbers in the lower bound column.

Three examples of the use of upper bounds and lower bounds are shown at 497. In the first example, the inputs shown in the “forward” row create a 9% upper bound and a 1% lower bound with respect to the allocation of forward contracts in either the contractual assets portfolio or the counterbalancing portfolio. In the second example, the inputs shown in the “option” row create a 6% upper bound and a 1% lower bound with respect to the allocation of options in either the contractual assets portfolio or the counterbalancing portfolio. In the third example, the inputs shown in the “bond” row create a 10% upper bound and a 1% lower bound with respect to the allocation of bonds in either the contractual assets portfolio or the counterbalancing portfolio.

FIG. 4D is a screenshot a graphical display when the display is used to inform a user about how a bank's current portfolios compare to the optimized portfolios identified by the liquidity planning system. The display functionality for comparing current and optimized portfolios, as shown in FIG. 4D, may be applied to comparing a current contractual assets portfolio to an optimized contractual assets portfolio. The functionality may also be applied to comparing a current counterbalancing portfolio to an optimized counterbalancing portfolio.

In FIG. 4D, at 455, a pie chart generated as a result of the system optimization is displayed. The pie chart 455 depicts the structure of a bank's current portfolio (this portfolio could be either a contractual assets portfolio or counterbalancing portfolio). Each slice of the pie chart corresponds to a type of asset, cash flow generating instrument, or credit facility. A second pie chart at 457 depicts what the structure of the bank's current portfolio would be upon implementing the asset allocations of the optimized portfolio. The inner portion of the pie chart 457 depicts the allocations associated with a first optimized portfolio that the liquidity planning system has identified using a first set of constraints. The outer portion of the pie chart 457 depicts the allocations associated with a second optimized portfolio that the liquidity planning system has identified using a first set of constraints.

A graphical display may also enable a user to visualize a bank's cash inflows and cash outflows over time, net liquidity gaps and cumulative gaps, hedged cumulative gaps, and liquidity reserves. FIG. 4E is a screenshot 499 of the graphical display when this functionality is activated on the display.

FIG. 5 illustrates certain liquidity planning system operations and the sources of data involved in these operations when the liquidity planning system 300 is used to determine an optimal counterbalancing portfolio for a bank or financial institution. As depicted in FIG. 5, a political events generator 630 processes a sample of political events represented by quantitative data (e.g. tax rates at various historical occasions) and generates a probability distribution that represents the rates of occurrence of different political events found in the historical sample. A macro-economic events generator 628 performs a similar process with regards to macro-economic data. A similar process is also performed by micro-economic events generator 618. The distributional data generated by the macro-economic events generator 628, political events generator 630 and micro-economic events generator is accessed by the randomization engine 620.

The simulation scenario generator 440 creates randomized scenarios that cover a length of time specified by the forecast horizon 624. The forecast horizon 624 is an adjustable parameter that may be set and modified based on a financial institution's planning strategy and outlook. The forecast horizon 624 specifies not only a length of time, but also the periodicity with which future events are simulated and analyzed. For example, the periodicity determines whether the simulation scenario generator 440 will generate scenarios to involve hypothetical future changes described on a weekly, monthly, quarterly or yearly basis, or according to some other scheduling.

The randomization engine 620 generates series of random numbers to include a series of random numbers for each of the simulation scenarios to be created for use in the optimization process and a subsequent Monte Carlo scenario analysis of the optimized portfolio. Each series of numbers includes one random number for each of the time periods on the liquidity planning horizon.

The randomization engine 620, which is part of the simulation scenario generator 440, maps each random number to a numerical representation of a political event, macro-economic event, and micro-economic event. The assignments of numbers to events involves a mapping that is based on the respective distributions of these classes of events. The events are then ordered in series by the simulation scenario generator 440 and based on the ordering of the respective random numbers to which they are mapped. When events are ordered in series, they constitute a complete scenario. For each time period in each scenario, the simulation scenario generator 440 uses correlation data to determine a cash flow impact.

An extreme scenarios elimination filter 613 takes an inputted stress test target parameter 612 and eliminates a portion of extreme scenarios. One purpose of the extreme scenario elimination filter 613 is to eliminate a small portion of extreme scenarios, so that these scenarios are not considered in the optimization that determines the allocation of assets in the contractual assets portfolio. The number of scenarios eliminated in this process is dictated by the inputted stress test target parameter 612. The stress test target parameter represents a level of portfolio liquidity shock resistance that is targeted, and is based on the bank's risk appetite and regulatory requirements.

The inputted stress test target parameter specifies the percentage of extreme scenarios that will be eliminated by the extreme scenario elimination filter. When extreme scenarios are eliminated, the liquidity planning system 300 does not consider them in the process of optimizing the contractual assets portfolio. Therefore, the portfolio should be expected to suffer negative cash flows that are not counterbalanced, in the event that any of the eliminated scenarios actually come to fruition. Following elimination of extreme scenarios, the remaining sample of simulation scenarios is stored at 640.

The number of extreme scenarios eliminated is determined based on the risk appetite represented by the stress test target parameter. The higher the bank risk appetite indicated by the stress test target parameter 612, the greater is the number of scenarios that will be eliminated by the extreme scenarios elimination filter 613.

The liquidity planning system determines scenario liquidity gaps for each period on the planning horizon, and under each of the scenarios stored at 640. The scenario liquidity gaps are stored at 604. The present bank balance sheet is the basis for determining the scenario liquidity gaps stored at 604. Information that represents the present bank balance sheet is stored at 602. The information about the present bank balance sheet 602 includes information about the bank's assets, liabilities, and the maturity dates of its liabilities.

The contractual cash flows optimization model 608 receives the scenario liquidity gaps for the various simulation scenarios not filtered at 613. The model 608 provides a lowest cost contractual assets portfolio capably of providing liquidity in all of the simulated scenarios 640. The model 608 also outputs a statistical summary 610 of the simulated results of using the optimal portfolio in each of the simulated scenarios.

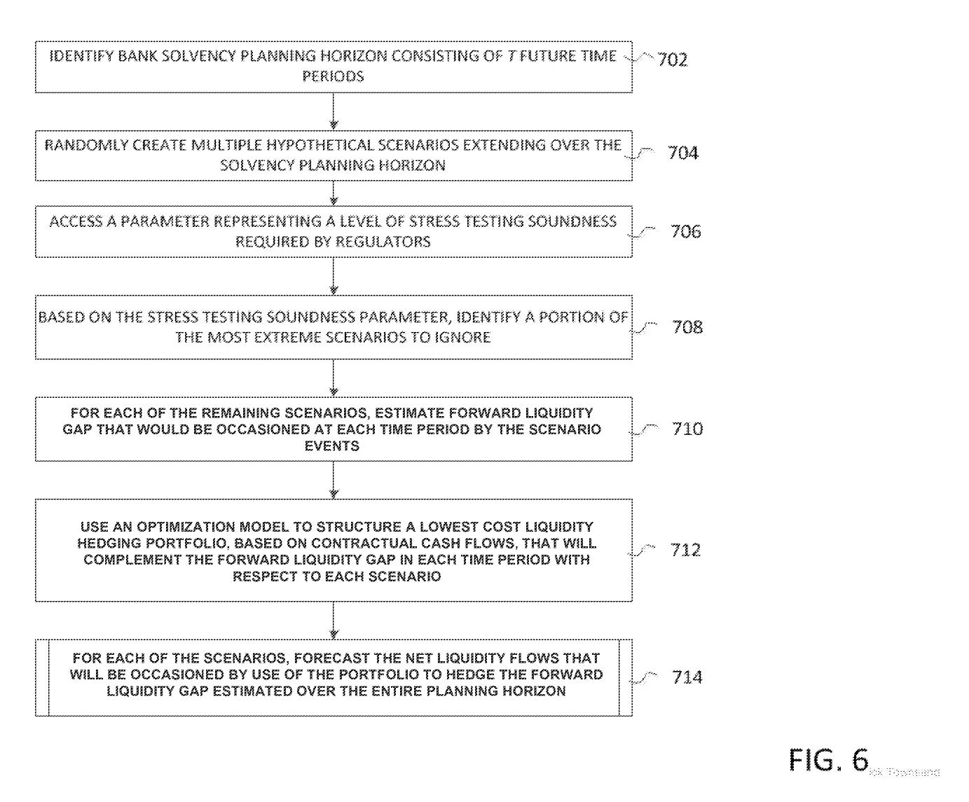

FIG. 6 is a flow diagram depicting example operations performed by the liquidity planning system during optimization of a counterbalancing portfolio of a bank. At 702, the liquidity planning system 300 identifies a bank liquidity planning horizon consisting of T future time periods. At 704, the simulation scenario generator 340 randomly creates multiple hypothetical scenarios extending over the liquidity planning horizon.

At 706, the liquidity planning system 300 accesses a parameter representing a level of stress testing soundness. An example of the parameter accessed at 706 is the stress test target parameter depicted previously in FIG. 6, at 612. As described previously, the parameter indicates a percentile of extreme scenarios to be disregarded in the process of optimizing the counterbalancing portfolio.

At 708, the liquidity planning system 300 identifies the scenarios to be disregarded, as established by the parameter accessed at 706. The liquidity planning system 300 subsequently disregards these scenarios during the remainder of the process depicted in FIG. 6 For each of the remaining scenarios, the liquidity planning system 300 estimates forward liquidity gap that would be occasioned at each time period by the scenario events. This estimation is depicted at 710.

At 712, the liquidity planning system 300 uses an optimization model to structure a lowest cost liquidity hedging portfolio having contractual cash flows that will complement the forward liquidity gap in each time period with respect to each scenario. The structuring of the lowest cost portfolio depicted at 712 includes suboperation 714. At 714, the liquidity planning system 300 forecasts net liquidity flows, in each of the scenarios, that would be occasioned by use of the portfolio to hedge the forward liquidity gap estimated over the entire planning horizon.

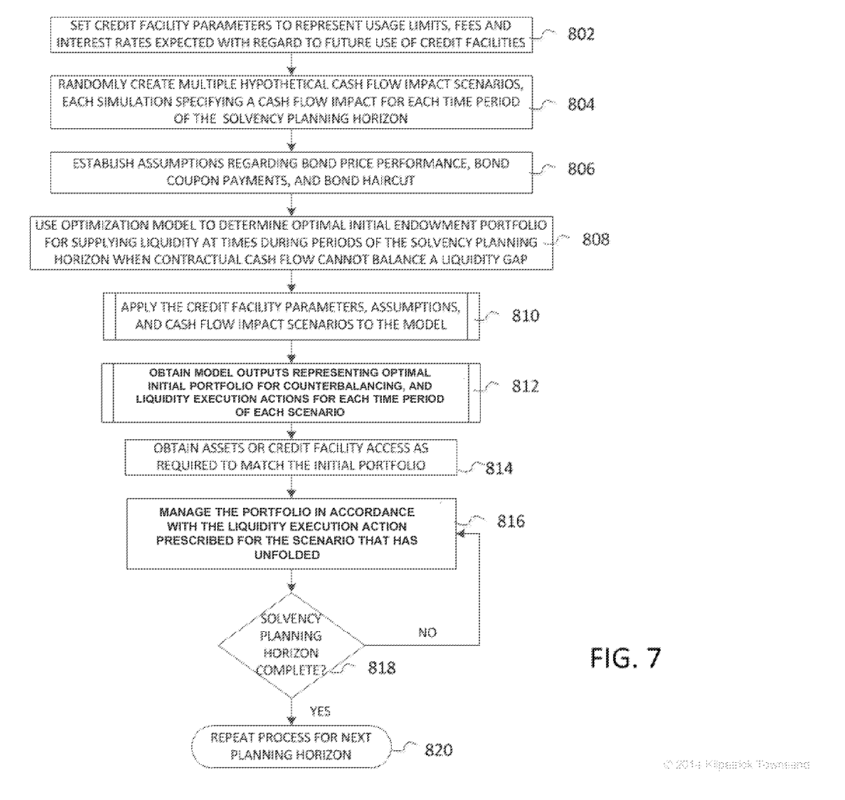

FIG. 7 is a flow diagram that depicts an example of operations that can be performed by the liquidity planning system 300 in order identify a lowest cost liquidity portfolio that is based on counterbalancing capacity and is forecasted to balance any liquidity gaps not covered by contractual assets in at least a minimum acceptable percentage of scenarios.

The operations depicted in FIG. 7 begin at 802. At 802, the liquidity planning system 300 sets credit facility parameters to represent usage limits, fees and interest rates expected with regard to future use of credit facilities. At 804, the liquidity planning system 300 randomly creates multiple hypothetical cash flow impact scenarios. Each scenario created at 804 specifies cash flow impacts for each time period of a solvency planning horizon. At 806, the liquidity planning system 300 establishes assumptions regarding bond price performance, bond coupon payments, and bond haircut. These assumptions can be inputted by a user, or can be obtained by applying a Brownian motion model.

At 808, the system 300 uses an optimization model to determine an optimal initial endowment portfolio for supplying liquidity at times during periods of the solvency planning horizon when contractual cash flows are not sufficient to balance a liquidity gap. Using the optimization model entails sub-operations (810-812) that are also depicted in FIG. 7 At 810, the liquidity planning system 300 applies the credit facility parameters, assumptions and cash flow impact scenarios to the model. At 812, the liquidity planning system 300 obtains outputs from the model representing the optimal initial portfolio for counterbalancing, and liquidity execution actions for each time period of each scenario. The liquidity execution (or deployment) actions can include selling assets, using assets to borrow cash flow, using cash assets, or borrowing from credit, for example.

At 814, the liquidity planning system 300 obtains the assets or credit facilities access prescribed for the initial portfolio. At 816, the liquidity planning system 300 manages the portfolio in accordance with the liquidity execution action prescribed, at 812, for the scenario that has unfolded.

At 818, if the solvency planning horizon is complete, the operations of FIG. 7 are repeated for a new solvency planning horizon. However, if future periods remain in the solvency planning horizon at 818, the process reverts to 816. Operations 816 and 818 are repeated until the solvency period ends.

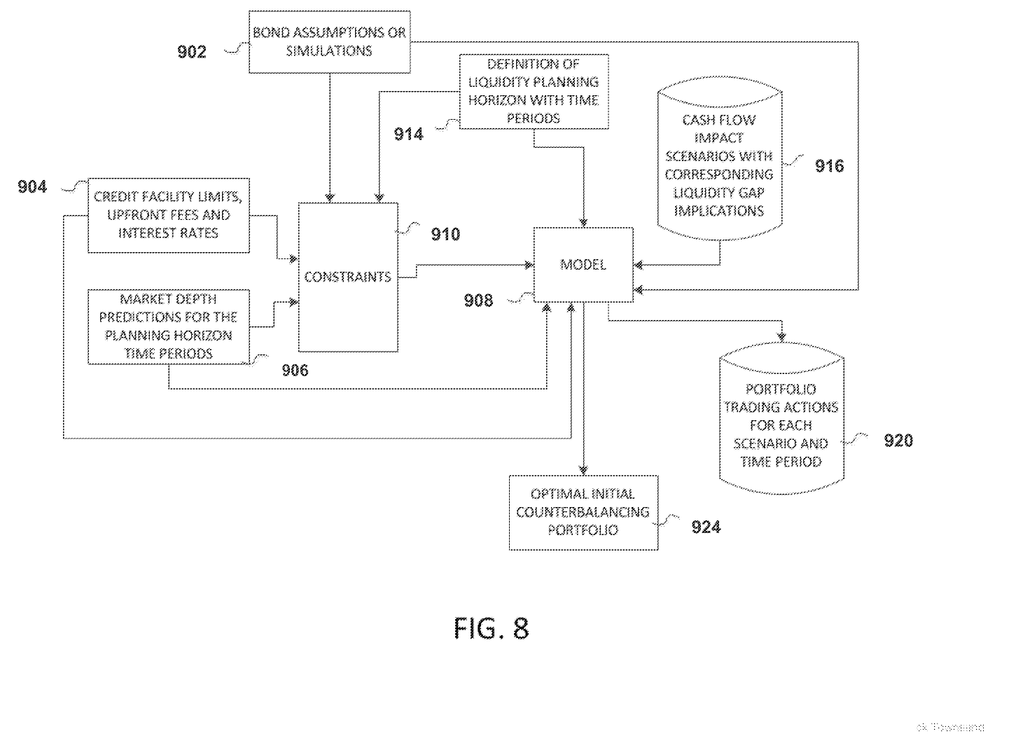

FIG. 8 is a diagram that shows an example of the data, assumptions and parameters that are used when the liquidity planning system executes the counterbalancing optimization model. The counterbalancing optimization model is depicted at 908, and is a linear programming model subject to constraints. The constraints used by the counterbalancing optimization model are depicted at 910.

Various parameters and assumptions are used in formulating the constraints, and in structuring the model 908. These assumptions and parameters include credit facility limits, upfront fees and interest rates are depicted at 904. They also include the planning horizon definition and its time periods 914, and the market depth predictions 906 for the planning horizon time periods. Bond assumptions and simulation information is also used in formulating the constraints, and is depicted at 902. The simulation information can include information about bond prices and returns that is generated from a Brownian motion simulation, or other type of simulation or model.

Cash flow impact scenarios with corresponding liquidity gap implications at 916 are also inputted to the model 908. The liquidity management system obtains the cash flow impact scenarios by generating random scenarios that are represented by political data, micro-economic data, and macro-economic data. The random scenarios are represented by fluctuations in key political, micro-economic and macro-economic variables. The, the liquidity management system uses historical financial institution information, investment information, economic information and variable correlations to derive cash flow impacts for each of the scenarios, and at each of the scenario time periods.

When the counterbalancing optimization model 908 is executed, the model provides two outputs. The first output is the optimal initial endowment for the counterbalancing portfolio, and is shown at 924. The second output is a series of counterbalancing portfolio trading recommendations for each scenario and time period in the liquidity planning horizon. These recommendations, which are depicted at 920, enable the counterbalancing portfolio to be optimally traded and managed in view of the actual developments that occur as time advances from one period to the next during the liquidity planning horizon.

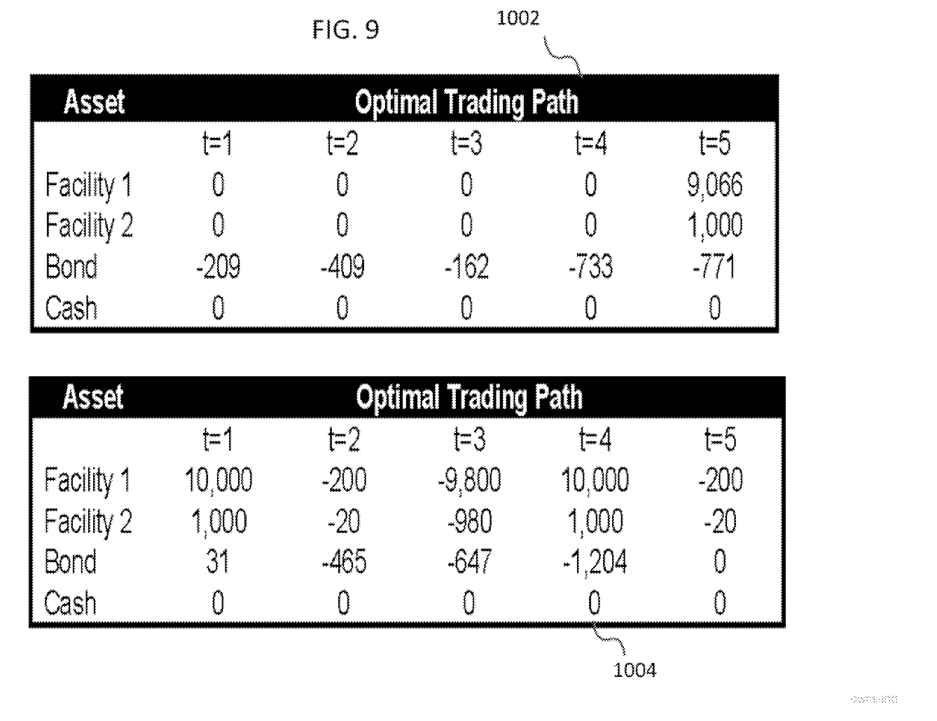

Examples of two series of counterbalancing portfolio trading and management actions recommended by the liquidity planning system are shown in FIG. 9. The first series of trading and management decisions is depicted at 1002, and involves 5 periods (t=1, t=2, . . . , t=5). The series of trading and management decisions is prescribed with regard to a counterbalancing portfolio that includes bonds, cash and access to two credit facilities. As depicted at 1002, the liquidity planning system has recommended liquidating bonds following the first through fifth period of the scenario. The liquidity planning system has also recommended accessing both credit facilities following the fifth time period. These recommendations, however, are computed with respect to a particular scenario and are prescribed as being optimal in the case of that specific scenario.

A second series of trading and management decisions is shown at 1004 with regard to the same counterbalancing portfolio the series of actions at 1002. However, the series of actions at 1004 is prescribed for a different scenario than series 1002, and therefore includes different actions. As depicted at 1004, the liquidity planning system has recommended accessing the first and second facility and acquiring bonds following the first period. The recommendation is that bonds be sold and money returned to the first and second facility following the second period, and following the third period. The recommendation is that bonds be sold following the fourth period, and that the first and second facility be accessed for cash. The recommendation following the fifth period is that money be returned to the first and second credit facility.

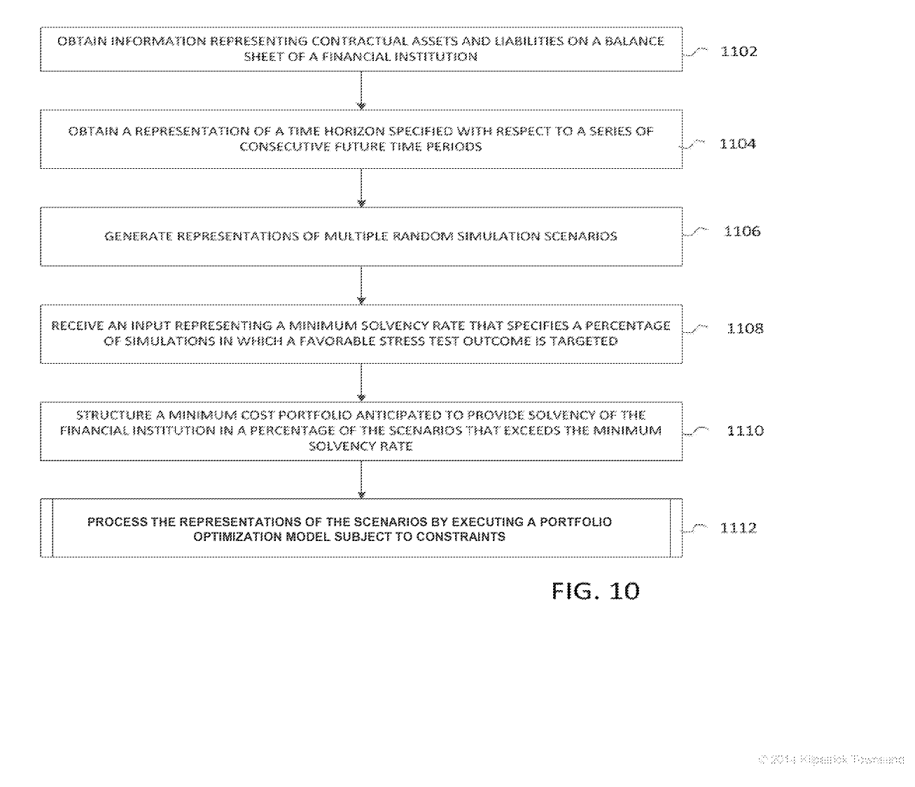

FIG. 10 is a flow diagram that illustrates example operations that may be used by the liquidity planning system described herein. At 1102, the liquidity planning system obtains financial information representing contractual assets and liabilities, for example, from a balance sheet of a financial institution. At 1104, the liquidity planning system obtains a representation of a time horizon specified with respect to a series of consecutive future time periods. At 1106, the liquidity planning system generates representations of multiple random simulation scenarios. At 1108, the liquidity planning system receives an input representing a minimum rate of solvency that specifies a percentage of simulations in which a favorable (e.g., solvent) stress test outcome is targeted.

At 1110, the liquidity management system structures a minimum plan, such as, for example, a minimum cost portfolio, that is anticipated to provide solvency of the financial institution in a percentage of the scenarios that exceeds the minimum solvency rate. Structuring the minimum cost portfolio at 1110 includes processing the representations of the scenarios by executing an optimization model subject to constraints, as depicted at 1112. The constraints can be linear and/or non-linear constraints.

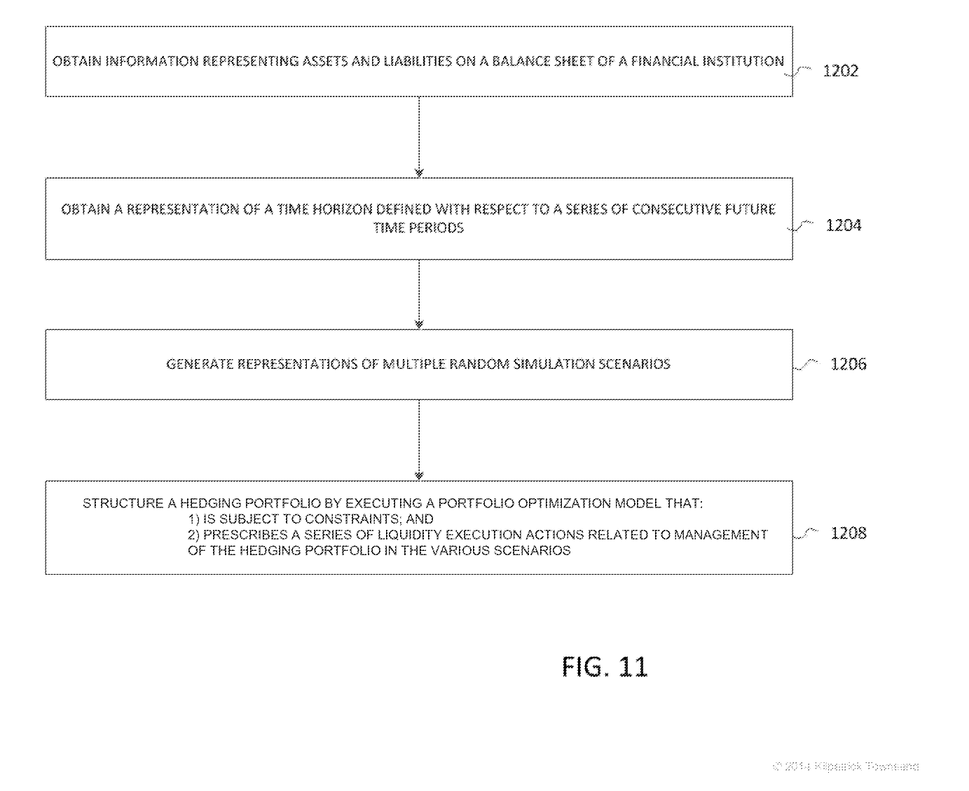

FIG. 11 depicts one example of operations that can be used in a liquidity planning system to structure an optimal counterbalancing portfolio. The operations begin at 1202 with the liquidity planning system obtaining information that represents assets and liabilities on a balance sheet of a financial institution. At 1204, the liquidity planning system obtains a representation of a time horizon defined with respect to a series of consecutive future time periods. At 1206, the liquidity planning system generates representations of multiple random simulation scenarios. At 1208, the liquidity planning system structures a hedging portfolio by executing an optimization model that is subject to constraints (linear and/or non-linear), prescribes a series of liquidity execution actions related to management of the hedging plan or portfolio in the various scenarios of the simulation.

The methods, systems, devices, implementations, and embodiments discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Some systems may use Hadoop®, an open-source framework for storing and analyzing big data in a distributed computing environment. Some systems may use cloud computing, which can enable ubiquitous, convenient, on-demand network access to a shared pool of configurable computing resources (e.g., networks, servers, storage, applications and services) that can be rapidly provisioned and released with minimal management effort or service provider interaction. Some grid systems may be implemented as a multi-node Hadoop® cluster, as understood by a person of skill in the art. Apache™ Hadoop® is an open-source software framework for distributed computing. Some systems may use the SAS® LASR™ Analytic Server in order to deliver statistical modeling and machine learning capabilities in a highly interactive programming environment, which may enable multiple users to concurrently manage data, transform variables, perform exploratory analysis, build and compare models and score. Some systems may use SAS In-Memory Statistics for Hadoop® to read big data once and analyze it several times by persisting it in-memory for the entire session.

Specific details are given in the description to provide a thorough understanding of examples of configurations (including implementations). However, configurations may be practiced without these specific details. For example, well-known circuits, processes, algorithms, structures, and techniques have been shown without unnecessary detail in order to avoid obscuring the configurations. This description provides examples of configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process that is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several examples of configurations, various modifications, alternative constructions, and equivalents may be used without departing from the spirit of the disclosure. For example, the above elements may be components of a larger system, wherein other rules may take precedence over or otherwise modify the application of the current disclosure. Also, a number of operations may be undertaken before, during, or after the above elements are considered. Accordingly, the above description does not bound the scope of the claims.

The use of “capable of”, “adapted to”, or “configured to” herein is meant as open and inclusive language that does not foreclose devices adapted to or configured to perform additional tasks or operations. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

1. A computer-program product comprising a non-transitory machine-readable storage medium that includes instructions operable to cause a data processing apparatus to perform operations including:
accessing information representing assets and liabilities of an entity;
accessing a representation of a time horizon specified with respect to a series of consecutive future time periods;
generating representations of multiple simulation scenarios on a computing device, wherein the multiple simulation scenarios include one or more impacts associated with hypothetical events during the time horizon, and wherein the one or more impacts are forecasted using the hypothetical events and the information representing assets and liabilities;
receiving input corresponding to a minimum rate for a simulation of future events associated with the multiple simulation scenarios, wherein the minimum rate specifies a percentage of simulation scenarios in which a stress test outcome is achieved; and
identifying a minimum plan for the entity, wherein executing the minimum plan meets or exceeds the minimum rate, wherein identifying the minimum plan includes processing the representations of the simulation scenarios by executing an optimization model subject to at least one constraint, and wherein the optimization model is executed on the computing device and corresponds to the minimum plan.

2. The computer-program product of claim 1, wherein identifying the minimum plan includes:
specifying, with respect to multiple asset classes, aggregate asset values in the minimum plan.

3. The computer-program product of claim 1, wherein at least one of the simulation scenarios further includes a series of impacts associated with a series of hypothetical events during the time horizon.

4. The computer-program product of claim 3, wherein the impacts include a cash flow impact with respect to each of the future time periods, and wherein at least one of the hypothetical events is a new loan contract hypothetically consummated by the entity during the time horizon.

5. The computer-program product of claim 1, wherein the at least one constraint includes at least one tail risk constraint.

6. The computer-program product of claim 1, wherein the at least one constraint includes Conditional Liquidity at Risk.

7. The computer-program product of claim 6, wherein the Conditional Liquidity at Risk is approximated using a cash flow mismatch optimization model with Conditional Value at Risk constraints.

8. The computer-program product of claim 7, wherein the cash flow mismatch optimization model includes a liquidity solvency probability as a deterministic parameter.

9. The computer-program product of claim 1, wherein the minimum plan is identified assuming that, during each of the future time periods, liquidity supplying capacity for hedging negative cash outflows is unavailable to the entity.

10. The computer-program product of claim 1, wherein the minimum plan is identified assuming that a positive overnight interest rate is zero throughout the time horizon.

11. The computer-program product of claim 1, wherein a representation of the minimum plan is used as a baseline condition within a hedging portfolio optimization model.

12. The computer-program product of claim 1, wherein the minimum plan provides solvency for the entity by generating positive cash inflows that replicate negative cash outflows during each of the future time periods.

13. A system comprising:
a processor configured to perform operations including:
accessing information representing assets and liabilities of an entity;
accessing a representation of a time horizon specified with respect to a series of consecutive future time periods;
generating representations of multiple simulation scenarios, wherein the multiple simulation scenarios are generated on a computing device and include one or more impacts associated with hypothetical events during the time horizon, and wherein the one or more impacts are forecasted using the hypothetical events and the information representing assets and liabilities;
receiving input corresponding to a minimum rate for a simulation of future events associated with the multiple simulation scenarios, wherein the minimum rate specifies a percentage of simulation scenarios in which a stress test outcome is achieved; and
identifying a minimum plan for the entity that meets or exceeds the minimum solvency rate, wherein identifying the minimum plan includes processing the representations of the simulation scenarios by executing an optimization model subject to at least one constraint, and wherein the optimization model is executed on the computing device and corresponds to the minimum plan.

14. The system of claim 13, wherein identifying the minimum plan includes:
specifying, with respect to multiple asset classes, aggregate asset values in the minimum plan.

15. The system of claim 13, wherein at least one of the simulation scenarios further includes a series of impacts associated with a series of hypothetical events during the time horizon.

16. The system of claim 15, wherein the impacts include a cash flow impact with respect to each of the future time periods, and wherein at least one of the hypothetical events is a new loan contract hypothetically consummated by the entity during the time horizon.

17. The system of claim 13, wherein the at least one constraint includes at least one tail risk constraint.

18. The system of claim 13, wherein the at least one constraint includes Conditional Liquidity at Risk.

19. The system of claim 18, wherein the Conditional Liquidity at Risk is approximated using a cash flow mismatch optimization model with Conditional Value at Risk constraints.

20. The system of claim 19, wherein the cash flow mismatch optimization model includes a liquidity solvency probability as a deterministic parameter.

21. The system of claim 13, wherein the minimum plan is identified assuming that, during each of the future time periods, liquidity supplying capacity for hedging negative cash outflows is unavailable to the entity.

22. The system of claim 13, wherein the minimum plan is identified assuming that a positive overnight interest rate is zero throughout the time horizon.

23. The system of claim 13, wherein a representation of the minimum plan is used as a baseline condition within a hedging portfolio optimization model.

24. The system of claim 13, wherein the minimum plan provides solvency for the entity by generating positive cash inflows that replicate negative cash outflows during each of the future time periods.

25. A computer-implemented method comprising:
accessing inputted information representing assets and liabilities of an entity;
accessing an inputted representation of a time horizon specified with respect to a series of consecutive future time periods;
using a computing device to generate representations of multiple simulation scenarios, wherein the multiple simulation scenarios are generated on the computing device and include one or more impacts associated with hypothetical events during the time horizon, and wherein the one or more impacts are forecasted using the hypothetical events and the information representing assets and liabilities;
accessing, on the computing device, an inputted minimum rate for a simulation of future events associated with the multiple simulation scenarios, wherein the minimum rate specifies a percentage of scenarios in which a stress test outcome is achieved; and
using the computing device to identify a minimum plan for the entity that meets or exceeds the minimum solvency rate, wherein identifying the minimum plan includes processing the representations of the simulation scenarios by executing an optimization model on the computing device, the optimization model subject to at least one constraint, and wherein the optimization model corresponds to the minimum plan.

26. The method of claim 25, wherein identifying the minimum plan includes:
specifying, with respect to multiple asset classes, aggregate asset values in the minimum plan.

27. The method of claim 25, wherein at least one of the simulation scenarios further includes a series of cash flow impacts associated with a series of hypothetical events during the time horizon.

28. The method of claim 27, wherein the impacts include a cash flow impact with respect to each of the future time periods, and wherein at least one of the hypothetical events is a new loan contract hypothetically consummated by the entity during the time horizon.

29. The method of claim 25, wherein the at least one constraint includes at least one tail risk constraint.

30. The method of claim 25, wherein the at least one constraint includes Conditional Liquidity at Risk.

31. The method of claim 30, wherein the Conditional Liquidity at Risk is approximated using a cash flow mismatch optimization model with Conditional Value at Risk constraints.

32. The method of claim 31, wherein the cash flow mismatch optimization model includes a liquidity solvency probability as a deterministic parameter.

33. The method of claim 25, wherein the minimum plan is identified assuming that, during each of the future time periods, liquidity supplying capacity for hedging negative cash outflows is unavailable to the entity.

34. The method of claim 25, wherein the minimum plan is identified assuming that a positive overnight interest rate is zero throughout the time horizon.

35. The method of claim 25, wherein a representation of the minimum plan is used as a baseline condition within a hedging portfolio optimization model.

36. The method of claim 25, wherein the minimum plan provides solvency for the financial entity by generating positive cash inflows that replicate negative cash outflows during each of the future time periods.
